(19) United States
(12) Patent Application Publication
(10) Pub. No.: US 2005/0262376 A1
(43) Pub. Date: Nov. 24, 2005

(54) Method and apparatus for bussed communications

(76) Inventor: Richard Austin McBain, Surrey (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 10/849,869

(22) Filed: May 21, 2004

(51) Int. Cl. G06F 13/00; G06F 1/04

(52) U.S. Cl. 713/600; 710/107

(57) ABSTRACT

Some embodiments of this invention relate to methods and apparatus for implementing bussed transactions between one or more components connected to a system bus. A clock generator circuit generates an independent clock signal for each component connected to the system bus. The clock generator circuit may use system signals, sideband busses, component signals, controller signals, arbiter signals or other means to determine the target component and/or the initiator component for a particular transaction. The individual clock signals may be gated or otherwise suppressed to selectively activate the components to participate in the transaction. If the components participating in a transaction are capable of operating at frequencies higher than the nominal system frequency, then the clock generator circuit may increase the frequency of the individual clock signals of the participating components during the course of the transaction. In particular embodiments, the system comprises one or more Cardbus or PCI slots for receiving Cardbus or PCI-compliant components.

### TECHNICAL FIELD

The invention relates to digital communications between components which share a data bus. Particular embodiments of the invention provide methods and apparatus for implementing bussed communications.

### BACKGROUND

Many types of electronic systems comprise two or more components for performing various functions which communicate digital information among themselves by way of a shared bus. An example of a system is a laptop computer, which comprises a central processing unit (CPU) and other components which may include a hard disc drive controller, a networking card and an audio controller card for example. Various embedded systems have similar architectures.

A bus includes a plurality of conductors that is shared between components of a system. A bus typically includes a number of conductors used for carrying data and a number of other conductors used for various communication control commands. Bussed communications are advantageous in that additional components may be connected to a bus and a separate communication link does not need to be separately provided for each component.

Typically, bussed communication systems operate on a particular standard or protocol. The protocol may specify, for example, the operating frequency/clock speed of the bus, the number of data bits (i.e. the width or data width of the bus), the functions of various command and/or data signals, the voltage levels for digital signals and other operating parameters. Components which use a bus for communications within a system must generally be operationally compliant with the bus communication protocol. A bus communication protocol is advantageous because it can allow components that are operationally compliant with the protocol to be added or substituted for one another within the system. In addition, where a system incorporates bussed communications and the bus communication protocol is in the public domain, any party may manufacture components which are compliant with the protocol and which may be used in the system. Thus, consumers who purchase a system, such as a laptop computer, are not forced to purchase components from the system manufacturer and may purchase operationally compliant components from third parties.

Transfers of data between components on a bus typically occur by way of communication “transactions”. The bus communication protocol typically specifies how a transaction is to occur on the bus (i.e. it includes a transaction protocol). Typically, the transaction protocol includes an addressing process for determining which of the system components should be participating in a particular transaction. If a component is determined to be involved in the transaction, then it will be configured to read data from or write data to the bus. Otherwise (i.e. when a component is determined not to be participating in a particular transaction), the component is configured to ignore the signals that are present on the bus.

One example of a bussed communication protocol is the Industry Standard Architecture (ISA) standard. Typical ISA systems operate at a frequency of 8 MHz with a data width of 16 bits. ISA busses are common in many older systems. For example, ISA busses were implemented in the IBM AT personal computer which used the Intel 80286 processor as a controller. Another example of a bussed communication standard is the Peripheral Component Interconnect (PCI) standard. PCI busses typically operate at a frequency of 33 MHz with a data width of 32 bits. Revisions of the PCI standard have included increases to the operating frequency (i.e. to 66 or 133 MHz) and the data width.

Some systems include a PCI bus and one or more PCI slots for connecting PCI-compliant components to the system. Typically, PCI-compliant components are implemented on and/or controlled by PCI cards which fit into the corresponding PCI slots. Often PCI slots are provided on a circuit board (e.g. the motherboard of a PC) which is the same circuit board that houses the bus. Accordingly, these PCI slots facilitate direct connection of PCI-compliant components to the PCI bus.

One drawback with PCI cards and PCI slots is that they are relatively large and, therefore, are not suitable for some systems where size, weight and/or mobility are important. For example, the use of PCI slots and PCI cards is not particularly suitable for adding peripheral components to mobile laptop computers.

In response to the need for systems that are small, light and mobile, various other bussed communication standards have been developed. One common interface standard in use today is the PC Card standard developed by the Personal Computer Memory Card International Association (PCMCIA). The PC Card interface standard is based on the ISA bus standard and has a 16 bit data width. Systems incorporating the PC Card interface standard typically comprise one or more PC Card slots. A PC Card component may be implemented on and/or controlled by a PC Card which plugs into one of the PC Card slots for connection to the system. PC Card slots and PC Cards are smaller than PCI slots and PCI cards.

Since the implementation of the PC Card standard, PCMCIA has developed a higher performance PC Card standard referred to as the Cardbus interface standard. The Cardbus interface standard is based on the PCI bus standard and has a 32 bit data width. Systems incorporating the Cardbus interface standard typically comprise one or more Cardbus slots. A Cardbus compliant component may be implemented on and/or controlled by a Cardbus card which fits into one of the Cardbus slots for connection to the system. The Cardbus standard has been designed to be backward compatible, such that Cardbus slots will also accommodate components that are implemented on and/or controlled by a 16 bit PC Card.

Systems incorporating the Cardbus interface standard and a system bus are currently implemented using one or more bridge circuits. A bridge circuit is an intermediary circuit between one or more Cardbus slots and the system bus. Typically, for systems using the Cardbus interface standard, the system bus is a 32 bit bus, such as a PCI standard bus. An example, of a Cardbus to PCI bus bridge circuit is the Texas Instruments PCI1220 PC Card Controller™. Bridge circuits, such as the PCI1220, typically decode the addressing portion of each transaction taking place on the system bus to determine whether one of its corresponding Cardbus components is the target component for a transaction. Bridge circuits also determine whether a connected Cardbus component is the initiator component for a transaction. If the bridge circuit detects that a particular one of its Cardbus components is participating in a transaction (i.e. as the initiator component or as the target component), the bridge circuit facilitates the transmission of signals between the system bus and individual pins of the corresponding Cardbus slot (and/or between individual pins of the Cardbus slot and the system bus). In this manner, the bridge circuit may effect the connections required for a transaction to occur between the participating Cardbus component and a component that is connected directly to the system bus. If the bridge circuit detects that any of its Cardbus components are not participating in a particular transaction, then the bridge circuit does not allow the transmission of signals between the system bus and the non-participating Cardbus components. Bridge circuits may also facilitate transactions between Cardbus components without using the system bus.

Cardbus compliant components are not directly connected to the system bus, because they are connected through a bridge circuit. In addition, Cardbus compliant components are not connected to one another using a common bus. The Cardbus bridge circuit effectively implements connection between the system bus and the individual Cardbus components and between the individual Cardbus components using point to point communications.

Bridge circuits add to the complexity and expense of interfacing Cardbus compliant components with a system. In addition, point to point communications (like those in the bridge circuit) are disadvantageous for systems incorporating multiple components, because point to point communications require separate conductors for each component and occupy an inordinate amount of space. An additional drawback with bridge circuits is that they may limit the speed of communications between the various components of a system.

Some systems incorporate relatively large numbers of Cardbus components and require more than one bridge circuit to effect the complex addressing between the multiple Cardbus components. The Interface Corporation's 6 slot Cardbus-to-Cardbus expansion system represents an example of a system incorporating a plurality of bridge circuits. In systems incorporating multiple bridge circuits, the complexity, expense and space disadvantages discussed above are exacerbated.

There is a general desire to implement systems which are capable of interfacing between one or more components and a system bus operating on a known bus standard that ameliorates at least some of the aforementioned disadvantages.

### SUMMARY OF THE INVENTION

A first aspect of the invention provides a method for conducting a transaction in a system incorporating a plurality of components connected to a system bus. The method comprises identifying participating components that are participating in the transaction from among the plurality of components and selectively providing each of the participating components with a corresponding clock signal for at least a portion of the transaction, while suppressing clock signals associated with any non-participating components. Once the clock signals are selectively provided to the participating components and suppressed from any non-participating components, the method involves writing data to and reading data from the system bus to perform the transaction. The method may also involve, upon determining that the transaction has ended, discontinuing suppressing the clock signals associated with non-participating components.

Writing data to the system bus may be performed by one of the participating components and reading data from the system bus is performed by another one of the participating components.

Suppressing the clock signals associated with any non-participating components may comprise suppressing one or more output signals of a clock generator circuit.

Identifying participating components that are participating in the transaction from among the plurality of components may comprise identifying a target component for the transaction and may comprise identifying an initiator component for the transaction. Identifying the target component for the transaction may involve using information obtained from at least one of: the system bus, a system controller, a system arbiter and one or more signals provided by one or more of the plurality of components. Identifying the initiator component for the transaction may involve using information obtained from at least one of: the system bus, a system controller, a system arbiter and one or more signals provided by one or more of the plurality of components.

Identifying the initiator component for the transaction may also comprise determining that the transaction is a configuration transaction for which a configuration controller is the initiator component. Determining that the transaction is a configuration transaction may comprise using information obtained from the configuration controller which indicates that the transaction is a configuration transaction. Identifying the target component for the transaction may comprise using information obtained from the configuration controller which indicates the target component for the transaction. Determining that the transaction has ended may comprise using information obtained from the configuration controller which indicates the end of the transaction. Such information may be communicated over a sideband bus.

The system and the system bus may conduct the transaction in accordance with a bussed communication standard selected from among: a PCI standard; a Cardbus standard and a variant of the PCI standard. Identifying the target component for the transaction may comprise independently monitoring a DEVSEL# pin associated with each of the plurality of components. Identifying the target component for the transaction may comprise independently monitoring a TRDY# pin associated with each of the plurality of components. Identifying the target component for the transaction may comprise monitoring AD<31:0> lines of the system bus during an address phase of the transaction and decoding the address asserted thereon. Identifying the initiator component for the transaction may comprise independently monitoring a GNT# pin associated with each of the plurality of components. Identifying the initiator component for the transaction may comprise independently monitoring a IRDY# pin associated with each of the plurality of components. Determining that the transaction is a configuration transaction may comprise monitoring C/BE<3:0># lines of the system bus during an address phase of the transaction. Determining the end of the transaction may comprise monitoring a FRAME# line on the system bus. Determining the end of the transaction may comprise monitoring a IRDY# line on the system bus.

If the participating components are capable of operating at a clock frequency that is higher than a nominal system clock frequency, then selectively providing each of the participating components with a corresponding clock signal for at least a portion of the transaction may comprise selectively providing each of the participating components with a corresponding clock signal at an increased frequency for a portion of the transaction and suppressing clock signals associated with any non-participating components may comprise providing clock signals to the non-participating components at a nominal system frequency. The method may comprise, upon determining that the transaction is coming to an end, manipulating the clock signals associated with the participating and/or non-participating components such that all components see valid timing on the bus. Manipulating the clock signals may comprise stretching one or more of the clock signals. Manipulating the clock signals may involve gating the clock signals for a predetermined period of time.

Another aspect of the invention provides a method for conducting a transaction in a system incorporating a plurality of components connected to a system bus. The method comprises identifying participating components that are participating in the transaction from among the plurality of components and if the participating components are capable of operating at a clock frequency that is higher than a nominal system clock frequency, selectively providing each of the participating components with a corresponding clock signal at an increased frequency for a portion of the transaction. The method also involves writing data to and reading data from the system bus to perform the transaction.

Another aspect of the invention provides a method for conducting a transaction in a system incorporating a plurality of components connected to a system bus. The method comprises: generating a plurality of clock signals, each of the plurality of clock signals corresponding to one of the of plurality components; identifying participating components that are participating in the transaction from among the plurality of components; and, based on which of the plurality of components are the participating components, adjusting one or more of the clock signals for at least a portion of the transaction. The method also involves writing data to and reading data from the system bus to perform the transaction.

Adjusting one or more of the clock signals for at least a portion of the transaction may comprise providing the participating components with their corresponding clock signals, while suppressing the clock signals associated with any non-participating components. Adjusting one or more of the clock signals for at least a portion of the transaction may comprise selectively providing the participating components with their corresponding clock signals at an increased frequency for a portion of the transaction, if the participating components are capable of operating at a clock frequency that is higher than a nominal system clock frequency.

Another aspect of the invention provides a system comprising a system bus and a plurality of components. Each of the components is connected directly to the system bus for conducting transactions with each of the other components over the system bus. The system also comprises a clock generator circuit for providing a plurality of clock signals. Each of the plurality of clock signals corresponding to one of the plurality of components. The clock generator circuit is configured to identify participating components that are participating in a transaction from among the plurality of components and, based on which of the plurality of components are the participating components, to adjust one or more of the clock signals for at least a portion of the transaction.

The clock generator circuit may be configured to provide the participating components with their corresponding clock signals, while suppressing the clock signals associated with any non-participating components. The clock generator circuit may be configured to selectively provide the participating components with their corresponding clock signals at an increased frequency for a portion of the transaction, if the participating components are capable of operating at a clock frequency that is higher than a nominal system clock frequency.

Further features and applications of specific embodiments of the invention are described below.

### BRIEF DESCRIPTION OF THE DRAWINGS

In drawings which depict non-limiting embodiments of the invention:

FIG. 1 is a schematic illustration of a system wherein a plurality of components are connected for bussed communication in accordance with a particular embodiment of the invention;

FIG. 2A is a schematic illustration of a method for operation of the FIG. 1 system to perform a transaction in accordance with a particular embodiment of the invention;

FIG. 2B is a schematic illustration of a method for operation of the FIG. 1 system to perform a configuration transaction in accordance with a particular embodiment of the invention;

FIG. 3 is a schematic illustration of a method for operation of the FIG. 1 system in accordance with a particular embodiment of the invention;

FIG. 4 is a schematic depiction of timing waveforms for a number of pins for a typical PCI read transaction;

FIG. 5 is a schematic depiction of timing waveforms for a number of pins for a typical PCI write transaction;

FIG. 6 is a schematic depiction of timing waveforms for a number of pins for a typical PCI configuration read transaction;

FIG. 7 is a schematic illustration of a system wherein a plurality of components are connected for bussed communication in accordance with a particular embodiment of the invention;

FIG. 8 is a schematic illustration showing the clock generator circuit of FIG. 7 in more detail;

FIG. 9 is a schematic illustration of a method for operation of the FIG. 7 system in accordance with a particular embodiment of the invention;

FIG. 10 is a schematic illustration of a system wherein a plurality of components are connected for bussed communication in accordance with another embodiment of the invention;

FIG. 11 is a schematic illustration of a method for operation of the FIG. 10 system in accordance with a particular embodiment of the invention;

FIG. 12 is a schematic illustration of a system wherein a plurality of components are connected for bussed communication in accordance with another embodiment of the invention;

FIG. 13 is a schematic illustration showing the clock generator circuit of FIG. 12 in more detail;

FIG. 14 is a schematic illustration of a method for operation of the FIG. 12 system in accordance with a particular embodiment of the invention;

FIG. 15 is a schematic illustration of the waveforms involved in a typical transaction according to the method of FIG. 14; and

FIG. 16 is a schematic illustration of a method for configuring a system which comprises components that use phase-lock-loop (PLL) timing circuitry.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Some embodiments of this invention relate to methods and apparatus for implementing bussed transactions between one or more components connected to a system bus operating on a known bus standard. In accordance with the invention, a clock generator circuit generates an independent clock signal for each component connected to the system bus. The clock generator circuit includes a mechanism for identifying which components are participating in a transaction. The clock generator circuit may use system signals, sideband busses, components signals, arbiter signals or other means to identify the target component and/or the initiator component for a particular transaction. The individual clock signals may be gated or otherwise suppressed to selectively activate the components to participate in the transaction. If the components participating in a transaction are capable of operating at frequencies higher than the nominal system frequency, then the clock generator circuit may increase the frequency of the individual clock signals of the participating components during the course of the transaction. When higher frequency clock signals are provided to participating components, the clock generator circuit may also manipulate the clock signals associated with non-participating components so that the non-participating components continue to operate correctly during the transaction and in subsequent transactions. In particular embodiments, the system comprises one or more Cardbus or PCI slots for receiving Cardbus or PCI-compliant components and a clock generator circuit for providing an independent clock signal to each Cardbus or PCI component.

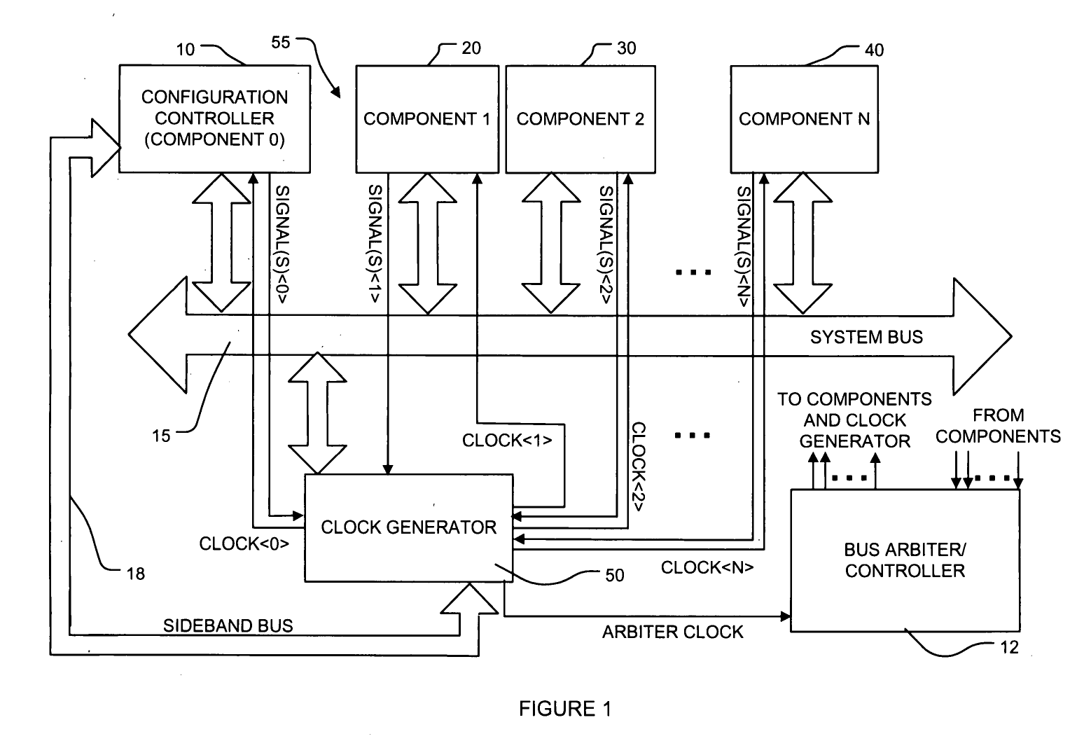

FIG. 1 depicts a system 55 in accordance with a particular embodiment of the invention. System 55 comprises a system bus 15 and a number of components 10, 20, 30, 40. Preferably, components 10, 20, 30, 40 are operationally compliant with a bussed communication and/or interface standard. For example, one or more of components 10, 20, 30, 40 may be operationally compliant with the PCI standard, the Cardbus standard, variants of the PCI standard such as cPCI, PC/104+ or other standards which are known to those skilled in the art or which will become known in the future. In this description, a component is said to be “operationally compliant” with a protocol or standard when it functions to perform at least basic transactions in a system incorporating the standard. A component that is “operationally compliant” may be, but need not be, strictly compliant with the specifications of the standard.

System 55 may comprise suitable slots or other connection interfaces (not shown) to accommodate components 10, 20, 30, 40. In the embodiment of FIG. 1, component 10 is a specialized component called a configuration controller which controls the configuration of system 55 as will be described further below. System 55 also comprises an arbiter 12 which is connected to each of components 10, 20, 30, 40. Arbiter 12 arbitrates between components 10, 20, 30, 40 to determine which component has control of system bus is.

System 55 may also comprise additional hardware (not shown), which is not germane to the present invention. Such additional hardware may include additional bus control hardware, power management hardware, interrupt controllers, additional components and the like. Such hardware may be programmed, configured or connected to perform a wide variety of functions. In general, such additional hardware may comprise any of a wide variety of hardware devices and systems known to those skilled in the art. System 55 itself may perform any of a variety of functions. System 55 may be an independent embedded system or may be a subsystem within a larger system (not shown). In general, the inventive aspects of system 55 should not be limited by the particular system in which they are deployed.

Other than configuration controller 10, system 55 is shown in FIG. 1 as comprising three additional components 20, 30, 40. In general, however, any practical number of components may be connected to system 55. Components 20, 30, 40 used in system 55 may generally comprise any type of digital and/or digitally controlled components that perform any type of tasks. Non-limiting examples of components that could be used in system 55 include networking components, communications components, memory components, video controller components, audio controller components and the like.

System 55 comprises a clock generator circuit 50, which is configured to independently supply a CLOCK<N:0>signal to each component 10, 20, 30, 40. In this description, a signal name followed by the notation <x:y> refers to a plurality of signals having the same signal name that ranges from the signal indexed by the reference “x” down to the signal indexed by the reference “y”. For example, CLOCK<N:0> refers to the plurality of CLOCK signals ranging from CLOCK<N> to CLOCK<0> and AD<31:0> refers to the plurality of AD signals ranging from AD<31> to AD<0>. In the embodiment of FIG. 1, clock generator circuit 50 is connected to receive one or more signals (SIGNAL(S)<N:0>) from each of components 10, 20, 30, 40. In the embodiment of FIG. 1, clock generator circuit 50 is also connected to receive one or more signals from system bus 15 and one or more signals from arbiter 12. These signals may be used by clock generator circuit 50 to obtain information about particular transactions occurring on system bus 15. For example, these signals may be used by clock generator circuit 50 to determine which of components 10, 20, 30, 40 are participating in a particular transaction. In other embodiments, clock generator circuit 50 need not be connected to all of system bus 15, arbiter 12 and individual components 10, 20, 30, 40 and may obtain information about particular transactions from any one or more of these sources.

In the embodiment of FIG. 1, system 55 comprises an optional sideband bus 18 for communication between clock generator circuit 50 and configuration controller 10. As described in more detail below, sideband bus 18 may be used to communicate configuration information between configuration controller 10 and clock generator circuit 50. In other embodiments, sideband bus 18 is not required, as clock generator circuit 50 obtains information about configuration transactions directly from system bus 15, from arbiter 12 or from the SIGNAL(S)<N:0> lines. In still other embodiments, sideband bus 18 is not required, as clock generator circuit 50 is configured as a component of system 55, such that clock generator circuit 50 may participate in transactions which occur on system bus 15 and may communicate with configuration controller 10 over system bus 15.

As explained in more detail below, clock generator circuit 50 outputs multiple CLOCK<N:0> signals, each of which corresponds to a particular one of components 10, 20, 30, 40. The multiple CLOCK<N:0> signals permit system 55 to address components for participation in a particular transaction that takes place on system bus 15. In general, such transactions may occur between any pair of components connected to system bus 15 (e.g. configuration controller 10 and components 20, 30, 40). In one particular application, the multiple CLOCK<N:1> signals provided by clock generator circuit 50 permit system 55 to address one of components 20, 30, 40 for participation as a target component in configuration transactions where configuration controller 10 is the initiator component.

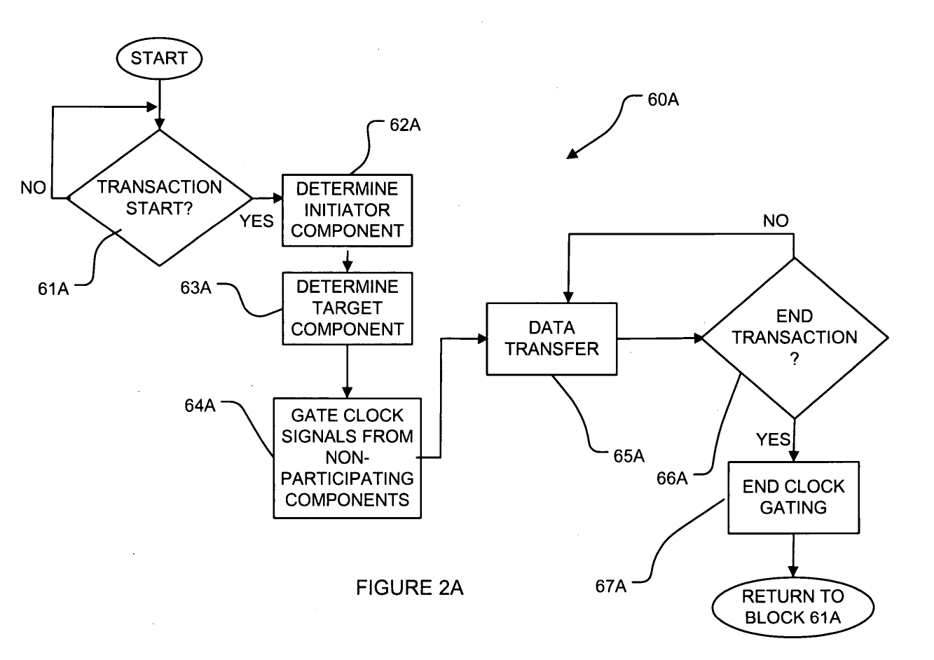

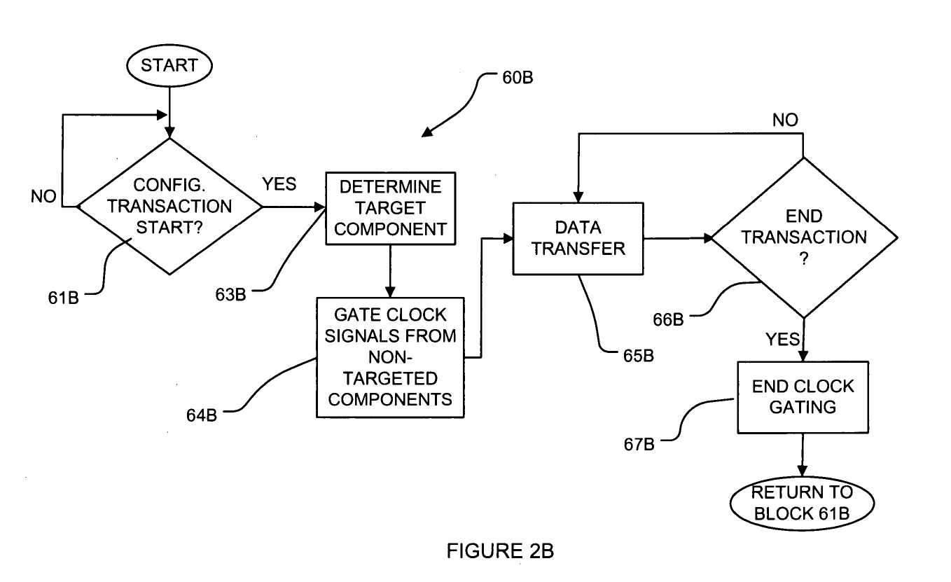

FIG. 2A schematically illustrates a method 60A for providing bussed communications transactions on system 55 (FIG. 1) according to a particular embodiment of the invention. After commencing, method 60A proceeds to block 61A, where it waits for a transaction to commence. Clock generator circuit 50 may determine when a transaction has commenced in block 61A by monitoring one or more particular signals on system bus 15, one or more of the signals provided by arbiter 12 and/or one or more of the SIGNAL(S)<N:0>from components 10, 20, 30, 40.

When a transaction commences, method 60A proceeds to block 62A which involves identifying which of components 10, 20, 30, 40 is the initiator component for the transaction. Clock generator circuit 50 may obtain information about which of components 10, 20, 30, 40 is the initiator component from particular signal(s) on system bus 15, from particular signal(s) provided by arbiter 12 and/or from particular SIGNAL(S)<N:0> provided by components 10, 20, 30, 40. In a preferred embodiment, arbiter 12 determines which of components 10, 20, 30, 40 is the initiator component for the next transaction to occur on system bus 15 and clock generator circuit 50 obtains this information from arbiter 12. After identifying the initiator component, the target component is identified in block 63A. Clock generator circuit 50 may determine which of components 10, 20, 30, 40 is the target component for the transaction using information from particular signal(s) on system bus 15, from particular signal(s) provided by arbiter 12 and/or from particular SIGNAL(S)<N:0>provided by components 10, 20, 30, 40.

Block 64A involves gating or otherwise suppressing the CLOCK signals associated with the non-participating components. Suppressing the CLOCK signals associated with non-participating components may be performed by clock generator circuit 50. For example, if it is determined in blocks 62A and 63A that component 20 is the initiator and that component 30 is the target for a particular transaction, then the non-participating components are component 10 and component 40. In such a circumstance, clock generator circuit 50 provides CLOCK<1> and CLOCK<2> to components 20, 30 respectively and suppresses CLOCK<0> and CLOCK<N>, such that components 10, 40 do not receive their respective CLOCK signals.

In block 65A, a data transfer occurs on bus 15. In keeping with the explanatory example, component 20 is the initiator component and component 30 is the target component. Because initiator component 20 receives CLOCK<1> and target component 30 receives CLOCK<2>, components 20, 30 participate in the data transfer (block 65A). However, since the non-participating components 10, 40 have their respective CLOCK signals suppressed, they do not take part in the data transfer of block 65A. Block 66A involves determining whether the transaction has terminated. Clock generator circuit 50 may determine when the transaction has terminated using information from particular signal(s) on system bus 15, from particular signal(s) provided by arbiter 12 and/or from particular SIGNAL(S)<N:0> provided by components 10, 20, 30, 40. If the transaction has not terminated, then method 60A returns to block 65A for another data transfer. However, if the transaction has terminated, then method 60A proceeds to block 67A where clock generator circuit 50 discontinues suppression of the CLOCK signals to the non-participating components. At the conclusion of block 67A, all of components 10, 20, 30, 40 are once again receiving their respective CLOCK<N:0> signals. Method 60A then returns to block 61A to await another transaction.

FIG. 2B schematically illustrates a method 60B for providing bussed communication configuration transactions on system 55 (FIG. 1) according to a particular embodiment of the invention. Systems use configuration transactions for a variety of purposes. For example, systems may use configuration transactions to establish an addressing scheme by assigning address information to the various system components. Such an addressing scheme may then be used in subsequent conventional transactions.

The configuration transactions of method 60B are similar in many respects to the generalized transactions of method 60A (FIG. 2A). However, configuration transactions contrast with conventional (i.e. non-configuration) transactions in that for most configuration transactions, configuration controller 10 is the initiator component. Accordingly, method 60B is a special case of method 60A, where it is known that configuration controller 10 is the initiator component.

Method 60B waits (block 61B) for a configuration transaction to commence. Clock generator circuit 50 may determine when a configuration transaction has started in block 61B by monitoring one or more particular signals on system bus 15, one or more of the signals provided by arbiter 12 and/or one or more of SIGNAL(S)<N:0> provided by components 10, 20, 30, 40. Additionally or alternatively, configuration controller 10 may provide clock generator circuit 50 with an indication that a configuration transaction is about to commence via sideband bus 18. The target component is determined in block 63B. Clock generator circuit 50 may determine which of components 10, 20, 30, 40 is the target component for the configuration transaction using information from particular signal(s) on system bus 15, from particular signal(s) provided by arbiter 12, from particular SIGNAL(S)<N:0> provided by components 10, 20, 30, 40 and/or from an indication of the target component provided by configuration controller 10 via sideband bus 18. In some cases, configuration controller 10 is both the initiator and the target of a configuration transaction. In such cases, configuration controller 10 may incorporate a hardware or software switch (not shown) which activates and deactivates its target configuration circuitry.

Block 64B involves gating or otherwise suppressing the CLOCK signals associated with the non-participating components. Clock generator circuit 50 provides CLOCK<0> to configuration controller 10 and suppresses the CLOCK<N:1> signals associated with the non-targeted ones of components 20, 30, 40. For example, if component 20 is the target component, then clock generator circuit provides CLOCK<1> to component 20 and suppresses CLOCK<2> and CLOCK<N>.

In block 65B, a data transfer occurs on bus 15. The participating components for the data transfer of block 65B (i.e. the components that receive their CLOCK signals) include configuration controller 10 (the initiator) and the target component determined in block 63B. Block 66B involves determining whether the transaction has terminated. Clock generator circuit 50 may determine when the transaction has terminated using information from particular signal(s) on system bus 15, from particular signal(s) provided by arbiter 12, from particular SIGNAL(S)<N:0> provided by components 10, 20, 30, 40 and/or from an indication provided by configuration controller 10 via sideband bus 18. If the transaction has not terminated, then another data transfer occurs (block 65B). If, however, the transaction has terminated, then method 60B proceeds to block 67B where clock generator circuit 50 discontinues suppression of the CLOCK signals. At the conclusion of block 67B, method 60B returns to block 61B to await another transaction.

In most bussed communication systems, transactions occur at a nominal CLOCK frequency. All of the system components are generally capable of operation at this nominal CLOCK frequency. However, in some cases, one or more components in a system are capable of operating at CLOCK frequencies higher than the nominal CLOCK frequency. For example, in system 55 (FIG. 1), one or more of components 10, 20, 30, 40 may be capable of operating at a frequency higher than the nominal CLOCK frequency. In circumstances where both the initiator component and the target component of a particular transaction are capable of operating at CLOCK frequencies higher than the nominal frequency, system 55 may conduct at least portions of certain transactions at higher CLOCK frequencies by independently providing increased frequency CLOCK signals to the participating components. In some such embodiments, clock generator circuit 50 outputs each of the CLOCK<N:0> signals at a variety of frequencies which may comprise a plurality of discrete frequencies. The maximum frequency at which system 55 may conduct portions of particular transactions is determined by the maximum operational frequencies of the components participating in the transaction. More particularly, lowest of the maximum operational frequency of the initiator component and the maximum operational frequency of the target component represents the maximum CLOCK frequency for a particular transaction. After each transaction, system 55 (and clock generator circuit 50) preferably revert to the nominal CLOCK frequency for all components 10, 20, 30, 40.

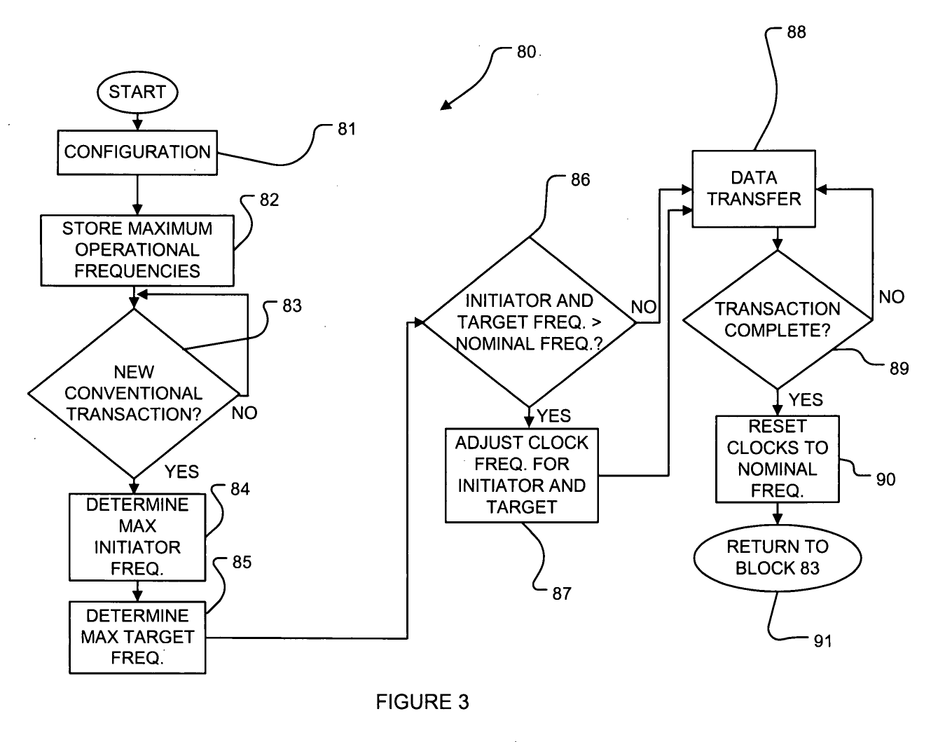

FIG. 3 schematically depicts a method 80 for providing bussed communications at various operational frequencies on system 55 (FIG. 1) according to a particular embodiment of the invention. For the purposes of explaining method 80, it is assumed that the nominal frequency of system 55 is 33 MHz. At the outset of method 80, system 55 configures itself in block 81. Block 81 may comprise one or more configuration transactions which occur at the nominal system frequency. Preferably, configuration controller 10 is the initiating component for the block 81 configuration transactions and the configuration transactions of block 81 are similar to the configuration transactions of method 60B (FIG. 2B) described above. In other embodiments, the block 81 configuration transactions are implemented using a bridge circuit that decodes the intended target component and provides point to point connections to the intended target component for each configuration transaction.

As a part of or at the conclusion of its configuration in block 81, system 55 determines the maximum operational frequency supported by each of its components 10, 20, 30, 40 and provides this information to clock generator circuit 50. Configuration controller 10 may obtain this maximum frequency information from itself and from components 20, 30, 40 using configuration transactions. In some cases, where particulars of components 20, 30, 40 are known, configuration controller 10 may be preprogrammed with this maximum frequency information. In block 82, the maximum operational frequencies for configuration controller 10 and components 20, 30, 40 are communicated to and stored by clock generator circuit 50. Clock generator circuit 50 may store this maximum frequency information in one or more memory registers (not shown). In preferred embodiments, configuration controller 10 probes itself and components 20, 30, 40 to obtain the maximum frequency information as a part of the configuration of system 55 using configuration transactions and communicates this information to clock generator circuit 50 via optional sideband bus 18. In other embodiments, clock generator circuit 50 is configured so as to be capable of participating in transactions on system bus 15 and either configuration controller 10 or the individual components 10, 20, 30, 40 communicate this maximum frequency information to clock generator circuit 50 via system bus 15. In still other embodiments, components 10, 20, 30, 40 communicate this maximum frequency information directly to clock generator circuit 50 via SIGNAL(S)<N:0>.

In block 83, system 55 waits for a conventional (i.e. non-configuration) transaction to start. It is assumed (for the ease of explanation of method 80) that all of the configuration transactions for system 55 were completed prior to entry into block 83. This assumption is not necessary, and method 80 may comprise an extra inquiry (not shown) to determine if a transaction is a configuration transaction or a conventional transaction. If a conventional transaction starts, then method 80 proceeds to block 84, which involves determining which component 10, 20, 30, 40 is the initiator component for the conventional transaction and the maximum operational frequency for the initiator component. Determination of the initiator component in block 84 may be substantially similar to determining the initiator component in block 62A of method 60A (FIG. 2A) discussed above. Once the initiator component is determined, then clock generator circuit 50 looks up the maximum operational frequency for the initiator component in its memory registers. For the purposes of explanation of method 80, it is assumed that the initiator component is component 20 and that the maximum operational frequency of initiator component 20 is 66 MHz.

Block 85 involves identifying which of components 10, 20, 30, 40 is the target component for the conventional transaction and the maximum operational frequency for the target component. Identification of the target component in block 85 may be substantially similar to identifying the target component in block 63A of method 60A (FIG. 2A) discussed above. Once the target component is determined, then clock generator circuit 50 looks up the maximum operational frequency for the target component in its memory registers. For the purposes of explanation of method 80, it is assumed that the target component is component 30 and that the maximum operational frequency of initiator component 20 is 133 MHz.

Block 86 involves determining whether both the initiator component and the target component are capable of operating at frequencies above the nominal frequency. If both the initiator and target components are capable of operating at frequencies above the nominal frequency, then the CLOCK signals corresponding to initiator component and target component are adjusted in block 87. In the example, where component 20 is the initiator and component 30 is the target, block 87 involves adjusting the frequency of CLOCK<1> and CLOCK<2>. The frequency increase in block 87 must be acceptable to both the initiator component and the target component. Accordingly, the maximum CLOCK frequency at the conclusion of block 87 is limited by the slower one of the initiator component and the target component. In the illustrative example, initiator component 20 is capable of operating at 66 MHz and target component 30 is capable of operating at 133 MHz. Consequently, block 87 involves increasing CLOCK<1> and CLOCK<2> to 66 MHz. The CLOCK signals for non-addressed components (i.e. in the example transaction, CCLK<0> of configuration controller 10 and CCLK<N> of component 40) are maintained at the nominal frequency. If the block 86 inquiry indicates that one (or both) of the initiator component and the target component are constrained to operate at the nominal frequency, then block 87 is bypassed and the corresponding CLOCK signals of the participating components are maintained at the nominal frequency for the duration of the transaction.

In block 88, a data transfer occurs on system bus 15. The data transfer of block 88 is substantially similar to the data transfers described above for block 65A of method 60A (FIG. 2A) and block 65B of method 60B (FIG. 2B), except that the data transfer of block 88 may occur at a higher frequency. Block 89 involves an inquiry into whether the transaction is complete. Clock generator circuit 50 may determine when the transaction has terminated using information from particular signal(s) on system bus 15, from particular signal(s) provided by arbiter 12, from particular SIGNALS<N:0> provided by components 10, 20, 30, 40 and/or from an indication provided by configuration controller 10 via sideband bus 18. If the block 89 inquiry indicates that the transaction is not completed, then method 80 loops back to block 88 for another data transfer.

On the other hand, if the transaction is completed, then method 80 proceeds to block 90. In block 90, all of the CLOCK<N:0> signals are reset to the nominal frequency. Block 90 may involve gating, extending or otherwise manipulating one or more of the CLOCK<N:0> signals to ensure that all of components 10, 20, 30, 40 are provided with valid CLOCK signals at the conclusion of the transaction. Method 80 then returns to block 83, where system 55 waits for a new transaction.

Particular embodiments of the invention are based on the PCI standard of bussed communication. The PCI standard is well known in the art and is described in many publications including, PCI Hardware & Software Architecture and Design, Edward Solari and George Willse, Annabooks, ISBN 0-929392-59-0 and PCI System Architecture, Tom Shanley, Mindshare, ISBN 0-201-40993-3, both of which are hereby incorporated by reference. A number of pins and basic PCI transactions are described herein for the purpose of facilitating a description of particular embodiments of the invention. Those skilled in the art will appreciate that the PCI standard incorporates a variety of pins, signals, transactions and functionalities which are not discussed herein. These different pins, signals, transactions and functionalities are well known in the art. The discussion of a number of the basic pins and basic PCI transactions contained herein should not limit the invention in any way.

The PCI standard specifies a number of pins/signals which are used to effect basic PCI transactions. In this description, pins having names which end with the symbol “#” are pins which are active low. A particular pin that is active low is said to be “asserted” when the pin is driven low and “deasserted” when the pin is driven high. Similarly, a particular pin that is active high is said to be “asserted” when the pin is driven high and “deasserted” when the pin is driven low.

The basic PCI pins include a system clock pin (CLK). In typical PCI systems, CLK provides the timing reference for all transfers on the PCI bus. For most PCI systems, CLK operates at a nominal frequency of 33 MHz. PCI versions of 2.0 and greater mandate correct operation of components at any frequency up to their maximum. Most such components allow changing of the clock frequency “on-the-fly”. However, PCI systems typically permit the nominal frequency of the CLK signal to be below 33 MHz. Some PCI standards have been developed for operation at 66 and 133 MHz. Typically, CLK is not a bussed signal and is individually connected to components in the system using point to point conductors. These point to point conductors preferably have the same length to minimize timing skew seen by the various components. Bussed signals in the PCI standard are normally sampled on the rising edge of the CLK signal.

In the PCI standard address and data signals are multiplexed onto the one set of 32 pins referred to as AD<31:0>. The AD<31:0> pins transfer 32 bits of address data during “address phases” and 32 bits of data during “data phases”. Address and data phases are explained further below. Bit 31 corresponds to the most significant bit on AD<31:0> and bit 0 corresponds to the least significant bit.

The PCI standard also includes four pins referred to as C/BE<3:0># for carrying multiplexed bus command and byte enable signals. During the address phase of a transaction, the four bits of C/BE<3:0># carry a bus command that defines the type of data transfer to be performed during the subsequent data phase(s) of the transaction. The four bits of C/BE<3:0># allow for 16 different commands, which include, inter alia, a memory read command, a memory write command, an I/O read command, an I/O write command, a configuration read command and a configuration write command. During the data phase(s) of a transaction, the four bits of C/BE<3:0># carry byte enable information indicating which bytes of data are valid, with C/BE<3># corresponding to the highest order data byte (i.e. AD<31:24>) and C/BE<0># corresponding to the lowest order data byte (i.e. AD<7:0>).

In a typical PCI transaction, one component is the initiator and one component is the target. Systems incorporating PCI standard buses include an arbiter. The arbiter arbitrates between initiator components which may be trying to assert control of the bus and determines one particular initiator component which may control the bus at any given time. Each PCI component connected to the system bus has a unique REQ# pin and a unique GNT# pin. The REQ# pin and GNT# pin of each PCI component are independently connected to the arbiter. An initiator component requests control of the bus from the arbiter by asserting its REQ# signal. The arbiter grants ownership of the bus to a particular initiator component by asserting the GNT# signal corresponding to that particular initiator component. Typically, the arbitration process takes place separately from the current transaction and does not consume clock cycles.

The PCI standard also includes a number of commonly used interface control pins, which are used to implement typical transactions. These pins include:
(i) FRAME#—FRAME# is a signal that bounds a transaction. On the next CLK cycle after an initiator component receives the GNT# signal from the arbiter, it asserts FRAME# to signal the start of a new transaction. The address phase of the transaction commences during the first clock cycle after the falling edge of the FRAME# signal. The initiator then holds FRAME# low until the last data phase of the transaction, whereupon the initiator deasserts FRAME# to indicate that the transaction should terminate at the conclusion of the current (i.e. last) data phase;
(ii) IRIDY#—The initiator component asserts IRDY# to indicate that the initiator is ready to complete a data phase. During a write operation, the assertion of IRDY# indicates that the initiator component has placed valid data on AD<31:0>; conversely, during a read operation, the assertion of IRDY# indicates that the initiator component is ready to accept data from AD<31:0>. Once IRDY# is asserted, it is typically held low by the initiator until TRDY# (see below) is asserted to complete the data phase;
(iii) TRDY#—The target component asserts TRDY# to indicate that the target is ready to complete a data phase. During a write operation, the assertion of TRDY# indicates that the target component is ready to accept the data on AD<31:0>; conversely, during a read operation, the assertion of TRDY# indicates that the target component has placed valid data on AD<31:0>. Once TRDY# is asserted, the target component typically holds TRDY# low until IRDY# is asserted to complete the data phase;
(iv) DEVSEL#—The target component asserts DEVSEL# when the target component detects its address on AD<31:0> during the address phase of a transaction. Typically, DEVSEL# is asserted within three CLK cycles following the address phase. The target component asserts DEVSEL# until after the last data phase has completed; and
(v) IDSEL—IDSEL is a pin used for configuration read and configuration write transactions. IDSEL is typically driven by a controller which controls the configuration of a PCI system. IDSEL is unique for each component in the system (i.e. IDSEL is not necessarily part of the bus that is shared between components). Typically, the IDSEL signal is wired to a specific AD<31:0> pin associated with each PCI slot/component in the system. The IDSEL pin is used for addressing components during configuration transactions. A PCI component is the target of a configuration read or a configuration write transaction, when its corresponding IDSEL signal is high and the command placed on C/BE<3:0># pins during the address phase is a configuration read or a configuration write signal.

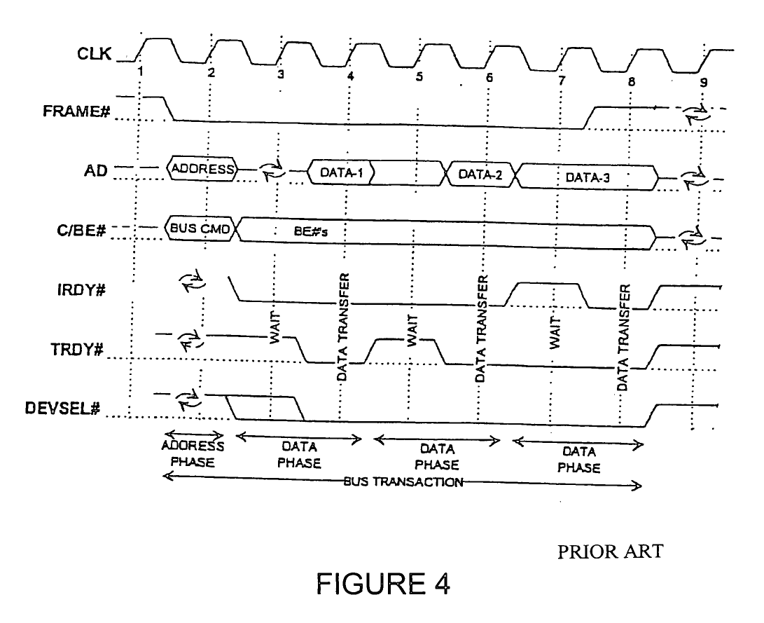

FIG. 4 schematically illustrates timing waveforms for a number of the pins involved in a typical PCI read transaction. The bus is idle in CLK cycle 1. During CLK cycle 1, the arbiter may be asserting the GNT# pin (not shown) for the initiator component of the FIG. 4 transaction, such that the initiator knows that it will have control of the bus on CLK cycle 2. The address phase of the FIG. 4 transaction occurs during CLK cycle 2, when the initiator asserts FRAME# to indicate that it has control of the bus. In the address phase, the initiator also drives the address of the target component on AD<31:0> and a read command on C/BE<3:0>#. In a typical PCI transaction, the address phase lasts for one CLK cycle.

In CLK cycle 3, AD<31:0> are tri-stated and TRDY# is held high for one clock cycle known as a “turnaround cycle”. The bus is idle in a turnaround cycle, to facilitate the transition between the application of address data to the AD<31:0> pins by the initiator (i.e. during the CLK cycle 2 address phase) and the application of read data to the AD<31:0> pins by the target (i.e. in the subsequent data phases). As part of CLK cycle 3, the initiator also asserts the relevant bits of C/BE<3:0># to provide valid byte enable information and asserts IRDY# to indicate that the initiator is ready to read data from the bus. When the target decodes the address (i.e. from AD<31:0>during the CLK cycle 2 address phase), the target asserts DEVSEL#. In the illustrated embodiment, the target may assert DEVSEL# in CLK cycle 3 or in CLK cycle 4.

In CLK cycle 4, the target asserts up to 32 bits of data on AD<31:0>, asserts DEVSEL# (if not already asserted in CLK cycle 3) and asserts TRDY# to indicate that the data on AD<31:0> is valid. Because IRDY# and TRDY# are both low during CLK cycle 4, a data transfer takes place (i.e. the first data phase of the FIG. 4 transaction) and the initiator reads the data on AD<31:0>.

It is assumed for the FIG. 4 transaction that the target is not ready to assert more data onto AD<31:0> in CLK cycle 5. Accordingly, the target deasserts TRDY# in CLK cycle 5, such that no data transfer occurs. In CLK cycle 6, the target is ready again, so it asserts data on AD<31:0> and re-asserts TRDY#. Since IRDY# and TRDY# are both asserted during CLK cycle 6, the initiator reads the data from AD<31:0> and the second data phase of the FIG. 4 transaction occurs. In CLK cycle 7, the target holds TRDY# low and asserts more data onto AD<31:0>. However, it is assumed for the FIG. 4 transaction that the initiator requires more time before it is ready to accept the data. Accordingly, the initiator deasserts IRDY# in CLK cycle 7 and even though there is valid data asserted on AD<31:0>, no data transfer occurs. In CLK cycle 8, the initiator is ready to read data again, so it re-asserts IRDY# and reads the data from AD<31:0> such the third data phase of the FIG. 4 transaction occurs.

The initiator knows at CLK cycle 7 that the third data phase is the last data phase for the FIG. 4 transaction. However, the initiator component is prevented from deasserting FRAME# in CLK cycle 7 because IRDY# is high in CLK cycle 7, so the third data transfer cannot occur. In CLK cycle 8, however, when IRDY# is asserted, the initiator component deasserts FRAME# to indicate that the data on AD<31:0> during CLK cycle 8 represents the last data phase of the FIG. 4 transaction. In CLK cycle 9, IRDY#, TRDY# and DEVSEL# are deasserted for a clock cycle at the conclusion of the transaction. In the transaction of FIG. 4, AD<31:0> and C/BE<3:0># are tri-stated in CLK cycle 9. FRAME# may also be tri-stated in CLK cycle 9.

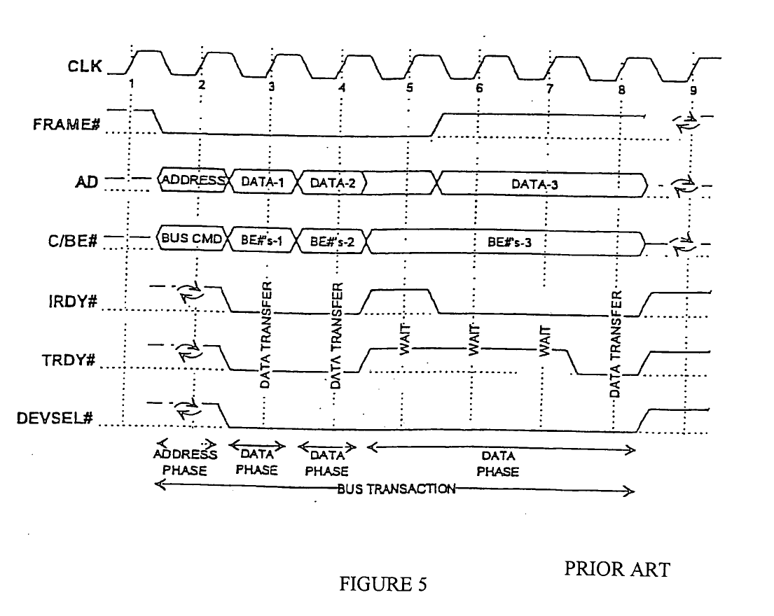

FIG. 5 schematically illustrates timing waveforms for a number of the pins involved in a typical PCI write transaction. In CLK cycle 1, the bus is idle. An initiator component takes control of the bus in CLK cycle 2 by asserting FRAME#. The address phase of the FIG. 5 transaction occurs in CLK cycle 2, when the initiator applies the address of the target component onto AD<31:0> and applies a write command on C/BE<3:0>#.

The first data phase of the FIG. 5 transaction occurs in CLK cycle 3. In CLK cycle 3, the target asserts DEVSEL# (to acknowledge that it has decoded the address asserted during the address phase of CLK cycle 2) and asserts TRDY# (to indicate that it is ready to receive write data). As a part of CLK cycle 3, the initiator drives valid write data on AD<31:0>, valid byte enable information on C/BE<3:0># and the initiator asserts IRDY# to indicate that valid write data is available. Since IRDY# and TRDY# are both low during CLK cycle 3, the data on AD<31:0> is written to the target and the first data phase of the FIG. 5 transaction occurs.

The write transaction of FIG. 5 does not require a turnaround cycle before the first data phase, because the initiator drives the bus (i.e. AD<31:0>) during both the address phase and the subsequent data phase(s). In contrast, the read transaction of FIG. 4 requires a turnaround cycle because the initiator drives the bus during the address phase and the target drives the bus during the subsequent data phase(s).

In CLK cycle 4 of the FIG. 5 transaction, the initiator provides new data on AD<31:0> and since IRDY# and TRDY# are both low, a second data phase occurs. In CLK cycle 5 of the FIG. 5 transaction, it is assumed that neither the initiator or the target are ready for a third data transfer, so IRDY# and TRDY# are both deasserted. In CLK cycle 6, the initiator is ready and applies data on AD<31:0> and asserts IRDY#. The initiator also deasserts FRAME# in CLK cycle 6 to indicate that the data on AD<31:0> represents the last data phase for the FIG. 5 transaction. Although the initiator was aware in CLK cycle 5 that the third data phase was the last data phase of the FIG. 5 transaction, it is prevented from deasserting FRAME# high when IRDY# is high, so it does not deassert FRAME# until CLK cycle 6.

It is assumed in the FIG. 5 transaction that the target is still not ready in CLK cycle 6 or CLK cycle 7. Consequently, the target maintains TRDY# high during these clock cycles. In CLK cycle 8, the target is ready and asserts TRDY#. As both TRDY# and IRDY# are low in CLK cycle 8, the third and last data phase of the FIG. 5 transaction occurs. In CLK cycle 9, IRDY#, TRDY# and DEVSEL# are deasserted for a clock cycle at the conclusion of the transaction. In the FIG. 5 transaction, AD<31:0> and C/BE<3:0># are tri-stated in CLK cycle 9. FRAME# may also be tri-stated in CLK cycle 9.

Prior to operating as described above, a system incorporating PCI standard bussed communications is normally configured. Configuration of a PCI system may involve, inter alia, configuring interrupts for the components, assigning memory and I/O addresses to each of the components and initializing the components to perform their various functions within the system. PCI-compliant components are required to have 256 bytes of addressable memory, known as “configuration address space” or “configuration registers,” for use during configuration. The 256 bytes of configuration address space is divided into 64 DWORDs, each DWORD having 4 bytes of 8 bits.

Configuration of the PCI system may be achieved using configuration transactions. In many respects, PCI configuration transactions are the same as the conventional (i.e. non-configuration) read and write transactions described above. However, the address phase of configuration transactions differs from that of conventional transactions. During the conventional read and write transactions described above, each individual component decodes its own address during the address phase to determine if it is the target for the transaction. However, prior to configuration, the components in the PCI system have not yet been assigned unique addresses and so the components must be addressed in a different manner.

Typically, the addressing of components during configuration is achieved using the IDSEL pin. Each component in a PCI system includes its own independent IDSEL pin. In typical embodiments, the IDSEL pin of each component is individually resistively coupled to a unique one of the AD<31:11> lines and functions as a selection signal. Accordingly, during the address phase of a configuration transaction, the initiator component drives the C/BE<3:0># pins to indicate that the command is a configuration command and asserts a particular one of the AD<31:11> pins. The one AD<31:11> pin corresponds to the IDSEL pin for the intended target component of the configuration transaction. When the IDSEL pin of the intended target is asserted, the target responds by asserting DEVSEL# to indicate that it knows that it is the intended target.

The lower order bits AD<10:0> are also used slightly differently during the address phase of a configuration transaction. AD<1:0> are used to indicate a type of configuration transaction for systems comprising multiple hierarchical PCI busses. AD<7:2> are used to specify a starting address (i.e. a starting DWORD) within the 256 bytes of configuration address space. For configuration transactions involving multiple data phases, the implied address of each subsequent data phase is one DWORD larger than the previous data phase. For example, if AD<7:2> is 000000 during the address phase of a configuration transaction, then the first data phase of the configuration transaction will access DWORD=000000 in the target component's configuration address space and the subsequent data phases of the configuration transaction will access DWORD=000001, 000010, 000011 . . . AD<10:8> are used to specify a particular type of configuration function for PCI components that support multi-function configuration. The three bits of AD<10:8> allow specification of a number of different functions for a particular multi-function component.

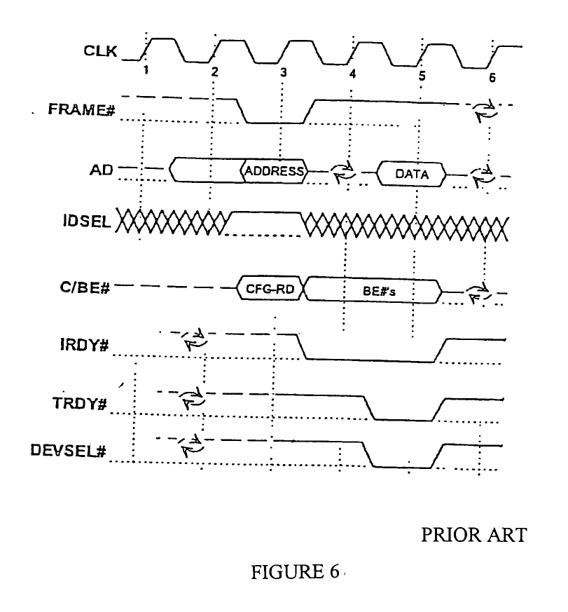

Waveforms for a number of pins involved in a typical configuration read transaction are schematically depicted in FIG. 6. In CLK cycle 1, the bus is idle. In CLK cycle 2, the initiator component asserts a selected one of the AD<31:11> lines (i.e. the line corresponding to the IDSEL pin of target component). Because of the resistive coupling, the IDSEL pin of the target may have a relatively slow slew rate and may have an indeterminate logic state for a period of time after the initiator asserts the selected AD<31:11> line in CLK cycle 2. This indeterminate logic state is shown in FIG. 6 by “XXX” marks on the IDSEL waveform. Because of this indeterminate logic state, a delay of one or more clock cycles may be implemented after the initiator asserts the selected AD<31:0> line in CLK cycle 2 and before the initiator asserts FRAME#. This delay ensures that the IDSEL pin of the target has reached a high logic state by the time that the initiator asserts FRAME#. In the FIG. 6 transaction, the delay is only one clock cycle and the initiator asserts FRAME # in CLK cycle 3.

The address phase of the FIG. 6 configuration transaction occurs in CLK cycle 3. The initiator continues to drive AD<31:0> in CLK cycle 3 and the IDSEL pin of the target component has reaches its high logic state. In CLK cycle 3, the initiator component also drives C/BE<3:0>#. In the address phase of CLK cycle 3, C/BE<3:0># indicate that the FIG. 6 transaction is a configuration read transaction, IDSEL indicates that a particular component is the target of the transaction, and AD<10:0> provide the indications discussed above.

IRDY# is asserted in CLK cycle 4 to indicate that the initiator component is ready to read data from the bus. However, CLK cycle 4 of the FIG. 6 transaction is a turnaround cycle similar to that of the FIG. 4 read transaction. TRDY# is deasserted and the AD<31:0> lines are tri-stated in preparation for accepting read data from the target. Because there is only one data phase in the FIG. 6 configuration transaction and because IRDY# is asserted in CLK cycle 4, the initiator deasserts FRAME# in CLK cycle 4 to indicate that the first data phase is also the last data phase for the FIG. 6 transaction.

In CLK cycle 5 of the FIG. 6 transaction, the target (which was addressed by the IDSEL signal in CLK cycle 3) asserts DEVSEL# and TRDY# and drives data onto AD<31:0>. The data comes from the DWORD of the target component which was addressed by AD<7:2> during CLK cycle 3. Since TRDY# and IRDY# are low in CLK cycle 5, a data phase takes place as the initiator reads data from AD<31:0>. Because FRAME# is high in CLK cycle 5, the system knows that the CLK cycle 5 data phase is the last data phase for the FIG. 6 transaction. Consequently, in CLK cycle 6, DEVSEL#, TRDY# and IRDY# are deasserted, AD<31:0> are tri-stated and the system returns to an idle state.

Those skilled in the art will appreciate that a typical configuration write transaction may be implemented in a manner that is similar to the configuration read transaction shown in FIG. 6. However, a configuration write transaction need not include a turnaround cycle, because the initiator drives the bus throughout the transaction.

As discussed above, the Cardbus interface standard is based on the PCI bussed communication standard. The pins/signals of the Cardbus standard are given names that are similar to the pins/signals of the PCI standard except that the Cardbus pin names are prefaced with a “C”. For example, IRDY# in the PCI standard is CIRDY# in the Cardbus standard and FRAME# in the PCI standard is CFRAME# in the Cardbus standard. The functionality of most Cardbus pins and the processes involved in most Cardbus transactions are substantially similar to the PCI pins and the PCI read and write transactions described above. Unless specifically noted otherwise, in this description and the accompanying claims, Cardbus signals and pin names should be understood to include corresponding PCI signals and pin names and vice versa.

As discussed above, prior art systems incorporating Cardbus cards require a PCI-to-Cardbus bridge to interface between a system bus and the Cardbus components. One difference between the PCI standard and the Cardbus standard relates to configuration transactions. The Cardbus standard does not provide an IDSEL pin. Accordingly, IDSEL can not be used to address Cardbus components during the address phase of a Cardbus configuration transaction. Accordingly, a Cardbus component will tend to respond to all configuration transactions that occur on the system bus, because it has no way of determining whether it is the intended target or not. Today's systems incorporating Cardbus components use PCI-to-Cardbus bridges to determine if one of their associated Cardbus cards is the target of a configuration transaction. The PCI-to-Cardbus bridge decodes the addressing portion of a configuration transaction and determines whether one of its associated Cardbus components is the target of a configuration transaction. If so, the PCI-to-Cardbus bridge will provide the appropriate configuration signals to the addressed Cardbus component via point to point conductors. As discussed above, PCI-to-Cardbus bridges add to the complexity and expense of interfacing Cardbus compliant components. In addition, the point to point conductors provided by the bridge for each Cardbus component occupy an inordinate amount of space. Bridge circuits may also limit the speed of communications to the various components.

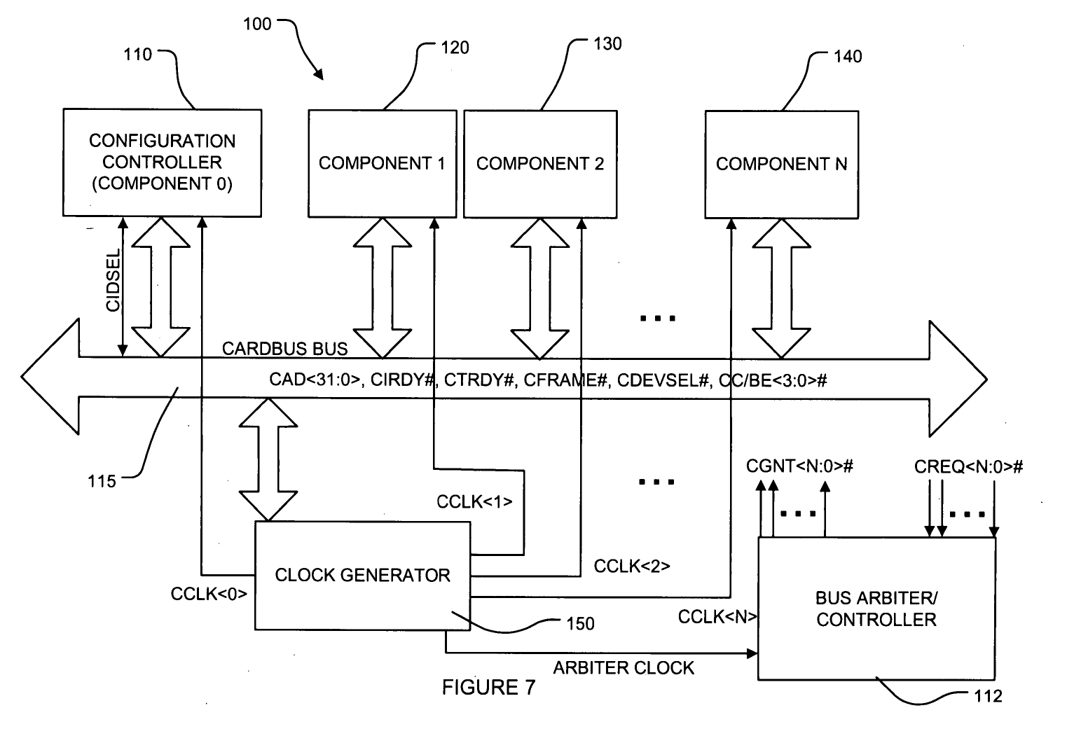

FIG. 7 is a schematic illustration of a system 100 according to a particular embodiment of the invention. System 100 represents a particular embodiment of system 55 (FIG. 1). System 100 comprises a configuration controller 110 and one or more components 120, 130, 140 which are directly connected to a system bus 115. System 100 also comprises a bus arbiter/controller 112. System bus 115 preferably operates on a PCI/Cardbus standard. In a preferred embodiment, configuration controller 110 and components 120, 130, 140 are Cardbus components (i.e. operationally compliant with the Cardbus standard), which are connected directly to system bus 115 via corresponding Cardbus slots (not shown) and without intervening bridge circuits. In general, however, configuration controller 110 and components 120, 130, 140 are not limited to Cardbus components. For example, one or more of configuration controller 110 and components 120, 130, 140 may be a PCI component (i.e. operationally compliant with the PCI standard), which may be connected to system 100 via a corresponding PCI slot (not shown). System bus 115, configuration controller 110 and components 120, 130, 140 may also be operationally compliant with variants of the PCI standard, such as cPCI, PC/104+ or with other standards which are known to those skilled in the art or which will become known in the future and which are capable of functioning as described herein. For the purposes of explanation of system 100, it is assumed that configuration controller 110 and components 120, 130, 140 are Cardbus components and that system bus 115 operates on the Cardbus/PCI standard, such that configuration controller 110, components 120, 130, 140 and system bus 115 are configured to make use of conventional Cardbus signals, including for example: CAD<31:0>, CIRDY#, CTRDY#, CFRAME#, CDEVSEL# and CC/BE<3:0>#.

System 100 may also comprise additional hardware (not shown), which is not germane to the present invention. Such additional hardware may include additional bus control hardware, power management hardware, interrupt controllers, additional components and the like. Such hardware may be programmed, configured or connected to perform a wide variety of functions. In general, such additional hardware may comprise any of a wide variety of hardware devices and systems known to those skilled in the art. System 100 itself may perform any of a variety of functions. System 100 may be an independent embedded system or may be a subsystem within a larger system (not shown). In general, the inventive aspects of system 100 should not be limited by the particular system in which they are deployed.

Other than configuration controller 110, system 100 is shown in FIG. 7 as comprising three additional components 120, 130, 140. In general, however, any practical number of components may be connected to system 100. Components 120, 130, 140 are preferably operational within systems using the Cardbus standard, PCI standard or PCI variant standard, such that they may be used interchangeably in system 100 and/or in the Cardbus slots, PCI slots or PCI variant slots of other external systems (not shown) without requiring substantial changes or modifications. Components 120, 130, 140 used in system 100 may generally perform any type of tasks. Non-limiting examples of components that could be used in system 100 include networking components, communications components, memory components, video controller components, audio controller components and the like.

System 100 also comprises a clock generator circuit 150 which is configured to supply CCLK<0> to configuration controller 110 and to supply one of the CCLK<N:1> signals to each component 120, 130, 140. The multiple CCLK<N:0> signals generated by clock generator circuit 150 permit system 100 to conduct configuration transactions and/or conventional (i.e. non-configuration) transactions over system bus 115 without a bridge circuit and without the point to point conductors associated with a bridge circuit. Such transactions may generally occur between any pair of components connected to system bus 115 (e.g. configuration controller 110 and components 120, 130, 140). The multiple CCLK<N:0> signals of clock generator circuit 150 also permit system 100 to be configured without using the individual IDSEL pins for each component 120, 130, 140 and without substantial modification to components 120, 130, 140.

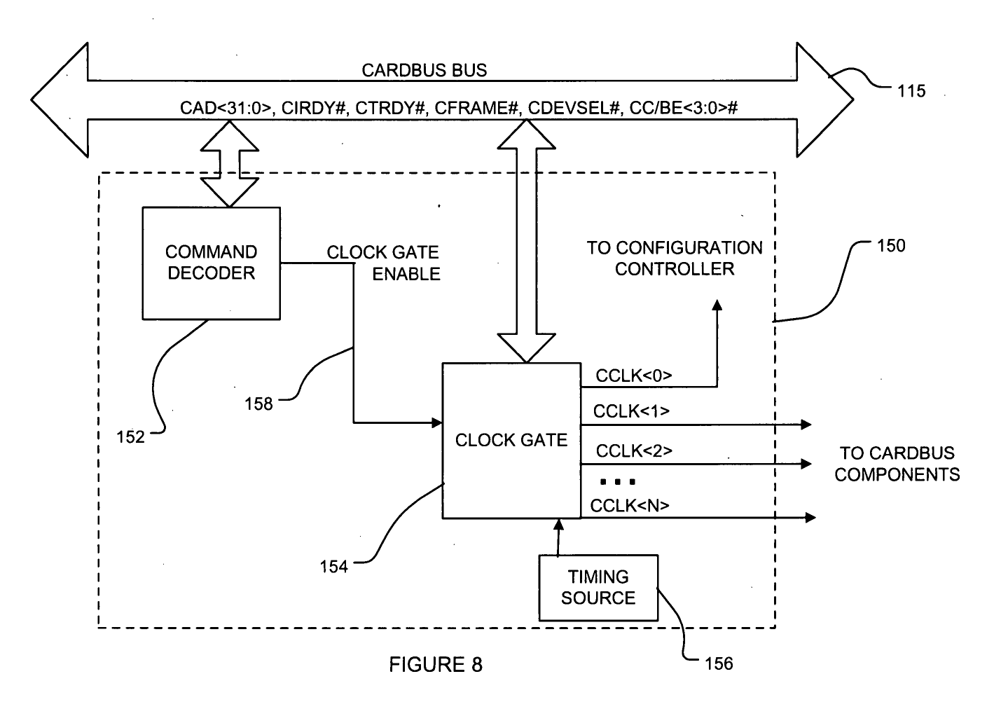

FIG. 8 is a schematic illustration showing a particular embodiment of clock generator circuit 150 in more detail. In the FIG. 8 embodiment, clock generator circuit 150 comprises a command decoder 152 coupled to system bus 115, a clock gate 154 coupled to system bus 115 and a timing source 156 which supplies a timing reference signal to clock gate 154. In some embodiments, command decoder 152 and clock gate 154 are coupled to a selected subset of the signals on system bus 115 to conserve space or save unnecessary connections.

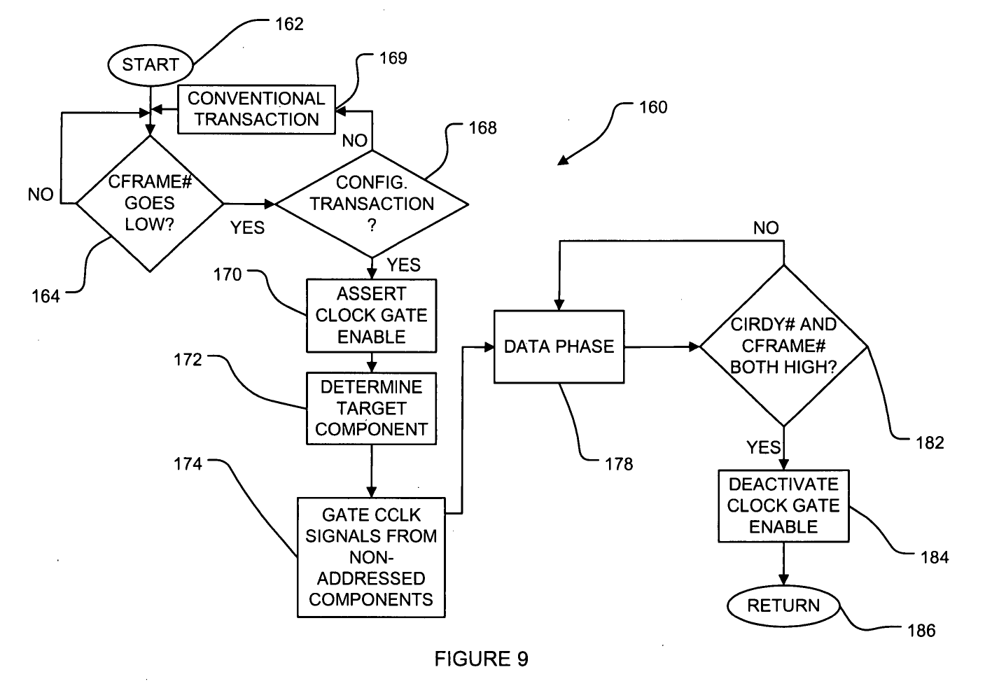

FIG. 9 schematically depicts a method 160 for providing bussed communications on system 100 (FIGS. 7 and 8) according to a particular embodiment of the invention. Method 160 commences in block 162 and proceeds to block 164, where it waits for a new transaction. While method 160 is waiting in the block 164 loop, clock gate 154 may output all of the CCLK<N:0> signals to configuration controller 110 and components 120, 130, 140. In other embodiments, the CCLK<N:0> signals (or selected ones of the CCLK<N:0> signals) are inactivated when system 100 is in an idle state to save power. In the embodiment of FIG. 7-9, command decoder 152 monitors system bus 115 during the block 164 loop, to determine if CFRAME# is asserted. The assertion of CFRAME# indicates the commencement of the address phase of a new transaction on system bus 115. On the assertion of CFRAME#, method 160 proceeds to block 168.

Block 168 involves determining whether the new transaction detected in block 164 is a configuration transaction. In the embodiment of FIGS. 7-9, block 168 is implemented by command decoder 152, which monitors the CC/BE<3:0># pins on system bus 115 during the address phase to determine if CC/BE<3:0># indicate a configuration transaction.

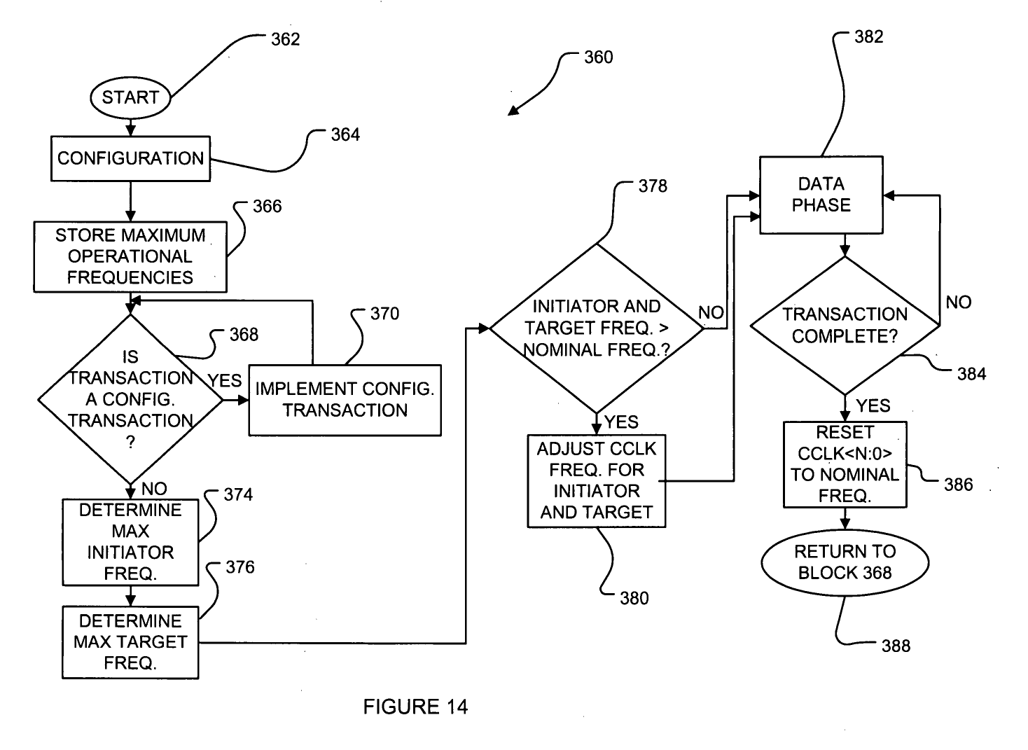

If CC/BE<3:0># indicate that a conventional (i.e. non-configuration) transaction is taking place, then a conventional transaction is conducted in block 169. Any one of configuration controller 110 and components 120, 130, 140 may be the initiator and/or the target of the block 169 conventional transaction. In some embodiments, clock gate 154 outputs all of the CCLK<N:0> signals for the block 169 conventional transaction. In such embodiments, the block 169 transaction may occur in a manner substantially similar to the conventional PCI transactions described above in FIGS. 4 and 5, except that each component receives its own CCLK signal. In such embodiments, the block 169 transaction may alternatively occur at higher speeds (i.e. with increased CCLK frequencies for the initiator and target components) in accordance with the conventional transactions described above in method 80 of FIG. 3 or in accordance with the conventional transactions described below in method 360 of FIG. 14. In other embodiments, the block 169 conventional transaction occurs in a manner similar to that described in FIG. 2A, where the CCLK signals associated with non-participating components are gated or otherwise suppressed. After completing a conventional transaction in block 169, method 160 loops back to block 164 where it waits for the next transaction.

In preferred embodiments of system 100 and method 160, configuration controller 110 is the initiator for configuration transactions. If, as a part of block 168, the CC/BE<3:0># pins on system bus 115 indicate that a configuration transaction is taking place, then command decoder 152 asserts a clock gate enable signal 158 (see FIG. 8) in block 170. The assertion of clock gate enable signal 158 in block 170 causes clock gate 154 to suppress those of the CCLK<N:1> signals corresponding to the non-addressed components.

In block 172, clock gate 154 identifies which one of components 120, 130, 140 is the target for the configuration transaction. In the embodiment of FIG. 7-9, clock gate 154 is coupled to the CAD<31:11> lines of system bus 315. Although there is no IDSEL pin for components 120, 130, 140 in system 100, the initiator component of the configuration transaction (preferably configuration controller 110) addresses the target component of the configuration transaction in the same manner as the PCI standard (i.e. by driving one of the CAD<31:11> lines of system bus 115 high during the address phase of the configuration transaction). In the embodiment of FIG. 7-9, clock gate 154 uses the information present on the CAD<31:11>lines of system bus 115 during the address phase to identify which one of components 120, 130, 140 is the target of the configuration transaction.

In block 174, after clock gate enable signal 158 is asserted (block 170) and the target component is identified (block 172), clock gate 154 continues to output a CCLK signal corresponding to the targeted one of the components 120, 130, 140 and gates or otherwise suppresses the other CCLK signals (i.e. the CCLK signals corresponding to the non-targeted components). For the purposes of explaining method 160, it is assumed that component 130 is the target component for the configuration transaction. In this circumstance, clock gate 154 provides the CCLK<2> signal to component 130 and suppresses the CCLK<1> and CCLK<N> signals corresponding to the non-addressed components 120, 140. In the embodiment of FIGS. 7-9, CCLK<0> is not suppressed by clock gate 154 during configuration transactions, as configuration controller 110 is the preferred initiator of configuration transactions.

A data phase then occurs in block 178. In keeping with the explanatory example, the initiator is configuration controller 110 and the target is component 130. Because target component 130 receives CCLK<2> and because initiating configuration controller 110 receives CCLK<0>, they take part in the block 178 data phase. However, the non-targeted components 120, 140, which have their respective CCLK signals suppressed, do not take part in the data phase of block 178. Block 182 involves determining whether the configuration transaction has terminated. In the embodiment of FIGS. 7-9, block 182 is implemented by having command decoder 152 monitor the CIRDY# and CFRAME# lines of system bus 115. Command decoder 152 may then determine that the configuration transaction has terminated when CIRDY# and CFRAME# are both deasserted. In other embodiments, the block 182 inquiry concludes that the transaction is complete as soon as CFRAME# is deasserted (i.e. without considering CIRDY#). If the configuration transaction has not terminated, then method 160 loops back to block 178 for another data phase.

If, however, the configuration transaction has terminated, then method 160 proceeds to block 184, where command decoder 152 sets clock gate enable signal 158 low. When clock gate enable signal 158 goes low, clock gate 154 discontinues suppression of the non-addressed CCLK signals. Accordingly, at the conclusion of block 184, all of the components 120, 130, 140 again receive their corresponding clock signals (CCLK<N:1>). After discontinuing suppression of the CCLK signals associated with the non-addressed components, method 160 returns from block 186 to block 164 to await another transaction.

The components of the FIG. 8 clock generation circuit 150 (i.e. command decoder 152, clock gate 154 and timing source 156) may be implemented on an otherwise passive backplane (not shown). Such a passive backplane may comprise Cardbus slots, PCI slots or PCI variant slots to which configuration controller 110 and components 120, 130, 140 may be connected. Such a passive backplane may comprise a printed circuit board of an embedded system, for example.

As discussed briefly above, configuration controller 110 (FIG. 7) may be a Cardbus component (i.e. operationally compliant with the Cardbus standard). Although configuration controller 110 may be modified as described below, configuration controller 110 is preferably capable of functioning as a conventional Cardbus component, such that it may be coupled to the Cardbus slot of an external system (not shown), such as a laptop computer, for example. Such an external system may be used to program and configure configuration controller 110 with instructions (i.e. code) which may be subsequently used by configuration controller 110 to configure system 100. For example, after configuration controller 110 is programmed by an external system, configuration controller 110 may be removed from the external system and coupled to system 100. The code programmed onto configuration controller 110 may then be used by configuration controller 110 to configure itself and the other components 120, 130, 140 of system 100.

Configuration controller 110 may be provided with minor modifications from the Cardbus standard. In some embodiments, configuration controller 110 comprises an internal configuration addressing pin (referred to herein as “CIDSEL”), which is comparable to the IDSEL pin of the PCI standard components described above, but which is not present in the Cardbus standard. In embodiments incorporating a CIDSEL signal, the CIDSEL signal is asserted during the address phase of configuration transactions where configuration controller 110 is configuring itself (i.e. configuration controller 110 is both the initiator and the target of the configuration transaction). The CIDSEL pin of configuration controller 110 may be resistively coupled to one of the CAD<31:11> lines on system bus 115. If the CAD<31:11> signal corresponding to the CIDSEL pin of configuration controller 110 is asserted during the addressing phase of a configuration transaction, then configuration controller 110 understands that it is the intended target of the configuration transaction.

Configuration controller 110 has is own clock signal CCLK<0>. As discussed above, CCLK<0> is not suppressed by clock gate 154 during configuration transactions, because configuration controller 110 is the initiator of most configuration transactions. However, when configuration controller 110 is not the intended target of a configuration transaction, it should be prevented from acting like a target component. Accordingly, if the CAD<31:11> line corresponding to the CIDSEL pin of configuration controller 110 is not asserted during the address phase of a configuration transaction, then configuration controller 110 recognizes that it is not the intended target of the configuration transaction and disables its target configuration circuitry. If configuration controller 110 is connected to an external system for programming, the CIDSEL pin of configuration controller 110 may be held high during the addressing phase of all transactions, such that the target configuration circuitry of configuration controller 110 remains active. The CIDSEL pin of configuration controller 110 may be held high in these circumstances by a software or hardware switch that is local to configuration controller 110.

In other embodiments, configuration controller 110 uses a software controlled signal 110 to determine when it is the target of a configuration transaction. Such a software signal may be connected to the CIDSEL pin or may be internal to configuration controller 110.

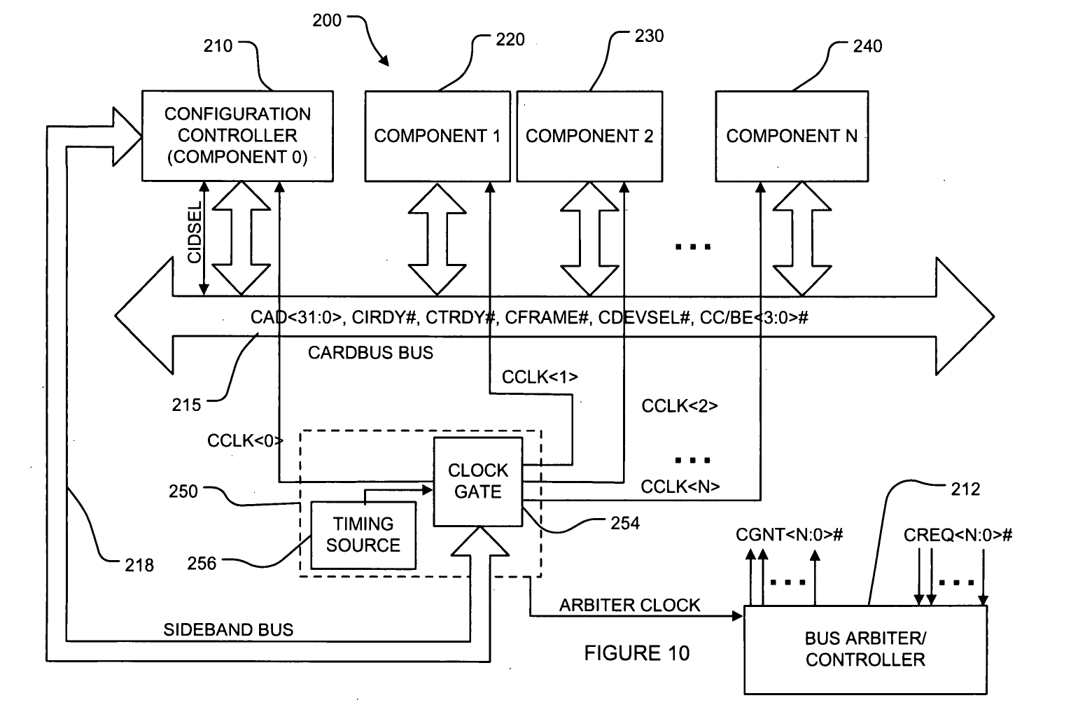

FIG. 10 depicts a system 200 according to another embodiment of the invention. In many respects, system 200 is similar to system 100 in that system 200 comprises a configuration controller 210, one or more components 220, 230, 240 which are coupled directly to a system bus 215 and a bus arbiter/controller 212. System bus 215 preferably operates on a PCI/Cardbus standard. In a preferred embodiment, configuration controller 210 and components 220, 230, 240 are Cardbus components (i.e. operationally compliant with the Cardbus standard), which are connected directly to system bus 215 via corresponding Cardbus slots (not shown) and without intervening bridge circuits. In general, however, configuration controller 210 and components 220, 230, 240 are not limited to Cardbus components. For example, one or more of configuration controller 210 and components 220, 230, 240 may be a PCI component (i.e. operationally compliant with the PCI standard), which may be connected to system 200 via a corresponding PCI slot (not shown). System bus 215, configuration controller 210 and components 220, 230, 240 may also be operationally compliant with variants of the PCI standard, such as cPCI, PC/104+ or with other standards which are known to those skilled in the art or which will become known in the future and which are capable of functioning as described herein. For the purposes of explanation of system 200, it is assumed that configuration controller 210 and components 220, 230, 240 are Cardbus components and that system bus 215 operates on the Cardbus/PCI standard.

System 200 also includes a clock generator circuit 250 that provides CCLK<0> to configuration controller 210 and provides one of CCLK<N:1> to each of components 220, 230, 240. System 200 may also include additional hardware (not shown) that is well known to those skilled in the art. System 200 may generally comprise any system. The inventive aspects of system 200 should not be limited by the nature of the particular system in which they are deployed. While three components 220, 230, 240 are depicted in the embodiment of FIG. 10, those skilled in the art will appreciate that system 200 may accommodate a different number of components and that components 220, 230, 240 used in system 200 may generally comprise any type of digital and/or digitally controlled components that perform any type of function.

System 200 of FIG. 10 differs from system 100 of FIGS. 7 and 8 in that system 200 incorporates software-based command decoding and software-based configuration addressing within configuration controller 110. Consequently, clock generator circuit 250 may be implemented using timing source 256 and clock gate 254 and does not require a command decoder (see command decoder 152 in FIG. 8). In addition, software-based configuration addressing within configuration controller 110 allows clock generator circuit 250 to be implemented without being coupled to system bus 215.

In the embodiment of FIG. 10, system 200 comprises a sideband bus 218 connected between configuration controller 210 and clock gate 254. Sideband bus may be connected to the Cardbus RFU (Reserved for Future Use) pins of configuration controller 210. As will be discussed in more detail below, configuration controller 210 uses sideband bus 218 to communicate configuration addressing information to clock gate 254. This configuration addressing information tells clock gate 254 which CCLK<N:1> signals to suppress during particular configuration transactions. In one particular embodiment of the invention, sideband bus 218 comprises a two-conductor bus according to the I²C™ bus standard developed by Phillips Semiconductors. In other embodiments, sideband bus is a variant of the I²C™ bus , such as SMbus™ or access.bus™ which may be based on the I²C™ standard. In other embodiments, sideband bus 218 is implemented using one or more signal lines which need not necessarily conform with a bussed communication standard.

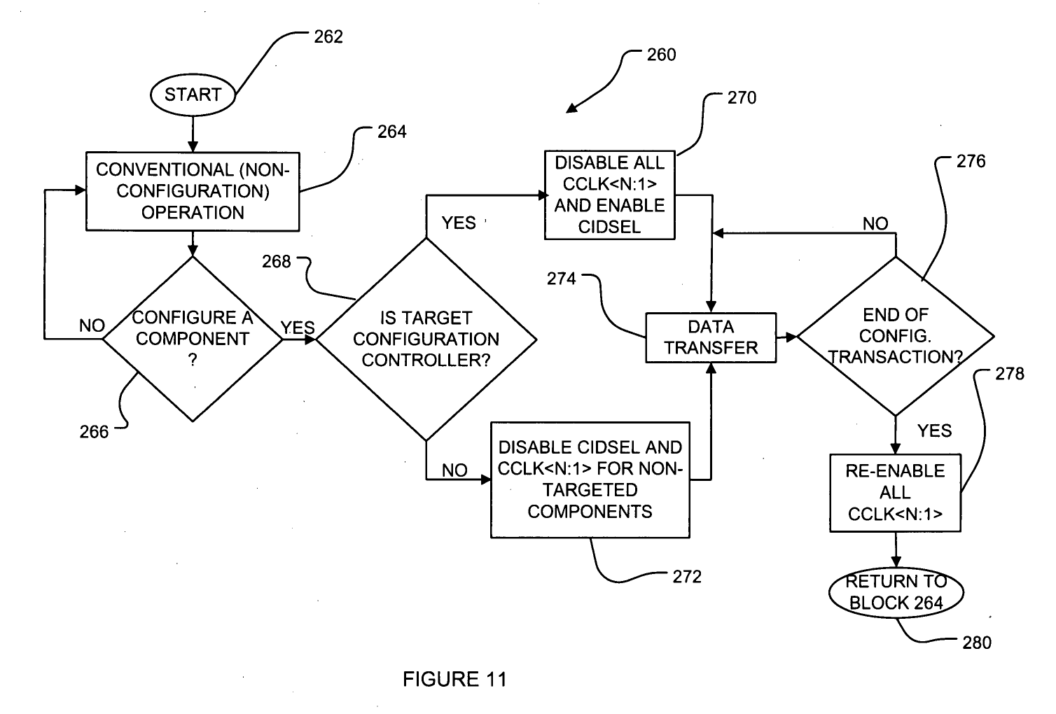

FIG. 11 schematically depicts a method 260 for providing bussed communications on system 200 (FIG. 10) according to a particular embodiment of the invention. Method 260 commences in block 262 and proceeds immediately to block 264. In block 264, system 200 operates in a conventional (i.e. non-configuration) mode. System 200 may conduct conventional (i.e. non-configuration) transactions in block 264. Any one of configuration controller 210 and components 220, 230, 240 may be the initiator and/or the target of the block 264 conventional transactions. Such conventional transactions may occur in accordance with any of the transaction methods described herein.

In block 266, the software running on configuration controller 210 determines whether it is to perform a configuration transaction. If not, then system 200 loops back to its block 264 conventional operational mode. If, on the other hand, a configuration transaction is required, then method 260 proceeds to block 268. The block 266 condition for commencing a configuration transaction may take a wide variety of forms. For example, after a system reset, the software on configuration controller 210 may have a particular configuration routine. In one particular example, such a configuration routine comprises a series of configuration transactions which probe whether there are components 220, 230, 240 connected to system 200 and, if so, another series of configuration transactions to configure the components 220, 230, 240. In another example, interrupt control hardware (not shown) detects the presence of a new component that is inserted into one of the available slots of system 200. In such a circumstance, the interrupt control hardware may trigger a subroutine programmed into configuration controller 210 to initiate one or more configuration transactions to configure the new component. In general, the invention should be considered to be independent of the specific condition or method by which system 200 determines that it should conduct a configuration transaction.

If it is determined that the software in configuration controller 210 is going to execute a configuration transaction, then method 260 proceeds to block 268. Block 268 involves determining whether configuration controller 210 is the target of the configuration transaction (i.e. configuration controller 210 is configuring itself). If configuration controller 210 is the target of the configuration transaction, then method 260 proceeds to block 270. In block 270, configuration controller 210 asserts the CAD<31:11> signal corresponding to its CIDSEL during the address phase of the configuration transaction. In block 270, configuration controller 210 also communicates with clock gate 254 via sideband bus 218 to instruct clock gate 254 to suppress all of the CCLK<N:1> signals, such that components 220, 230, 240 are prevented from participating in the configuration transaction because configuration controller 210 is the intended target. In block 270, configuration controller 210 preferably also locks out other components from initiating transactions on system bus 215 until the conclusion of the current configuration transaction. The software programmed into configuration controller 210 may be configured to lock out other components by sequentially configuring itself and then each component 220, 230, 240 in a series of individual transactions comprising multiple data phases, for example.

If, on the other hand, it is determined in block 268 that one of components 220, 230, 240 is the target of the configuration transaction, then method 260 proceeds to block 272. In block 272, configuration controller 210 deasserts the CAD<31:11> signal corresponding to its CIDSEL pin during the address phase of the configuration transaction. The CIDSEL pin of configuration controller 210 may be deasserted during the address phase because it is connected to one of the CAD<31:0> lines or because of a software signal as described above. When CIDSEL is deasserted during the address phase of a transaction, configuration controller 210 recognizes that it is not the intended target of the configuration transaction and disables its target configuration circuitry.

In block 272, configuration controller 210 also communicates with clock gate 254 via sideband bus 218 to instruct clock gate 254 to suppress the CCLK<N:1> signals corresponding to non-targeted components. If, for example, component 230 is the intended target of the configuration transaction, then configuration controller 210 instructs clock gate 254 (via sideband bus 218) to suppress all of CCLK<N:1> except for CCLK<2>. In this manner, component 230 is the only one of components 220, 230, 240 that participates in the configuration transaction. Clock gate 254 may comprise one or more clock control registers (not shown). Such clock control registers provide memory which can be used to control the application of the CCLK<N:0> signals. In one particular embodiment, configuration controller 210 instructs clock gate 254 to suppress the CCLK<N:1>signals corresponding to non-targeted components by writing an appropriate bit pattern (via sideband bus 218) to the appropriate clock control register(s) of clock gate 254.

A data phase occurs in block 274. The target of the data phase (block 274) will depend on whether method 260 arrived at block 274 via block 270 or block 272. In any case, clock gate 254 has disabled the appropriate CCLK<N:1> signals, so that only configuration controller 210 and the intended target component participate in the data phase (block 274). In block 276, method 260 continues to loop back to block 274 (i.e. to execute additional data phases) until configuration controller 210 determines that it is the end of the configuration transaction and communicates this information to clock gate 254. When the data transfer is complete, method 260 proceeds to block 278, where configuration controller 210 instructs clock gate 254 (via sideband bus 218) to re-enable all of the CCLK<N:1> signals. After re-enabling all of the CCLK<N:1> signals, method 260 proceeds to block 280 and then returns to conventional operation in block 264.

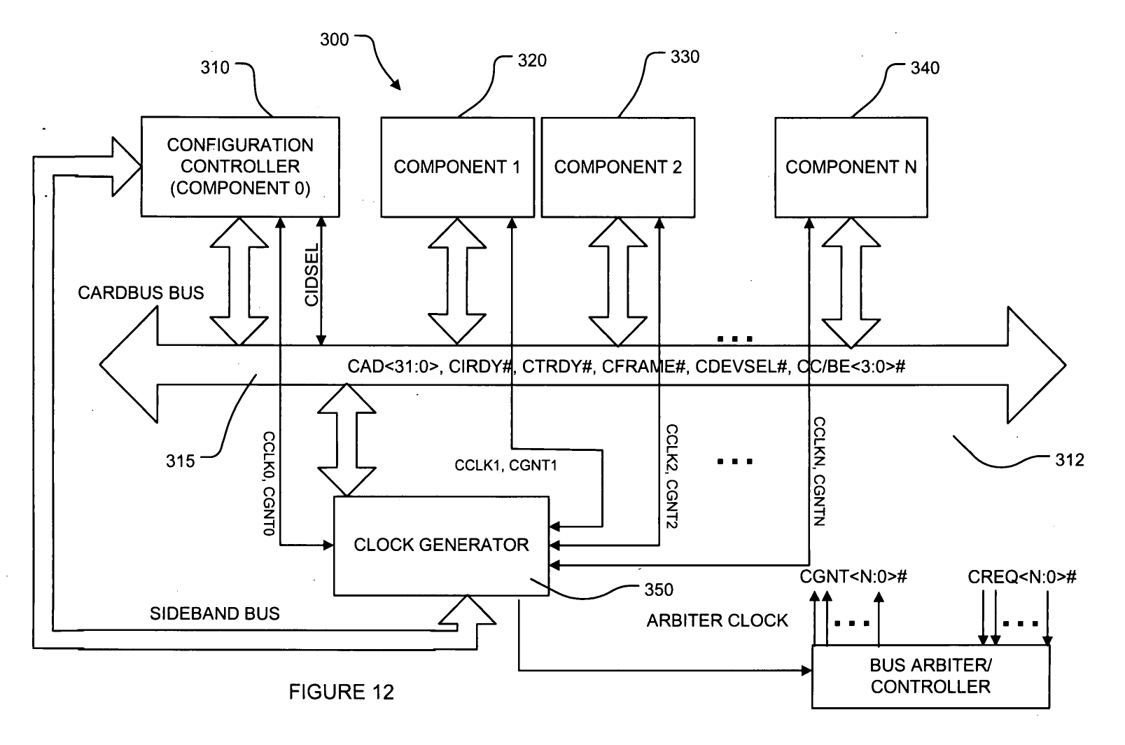

FIG. 12 illustrates a system 300 according to another embodiment of the invention. System 300 is similar to systems 100 and 200 in that system 300 comprises a configuration controller 310, one or more components 320, 330, 340 which are coupled directly to a system bus 315 and a bus arbiter/controller 312. System bus 315 preferably operates on a PCI/Cardbus standard. In a preferred embodiment, configuration controller 310 and components 320, 330, 340 are Cardbus components (i.e. operationally compliant with the Cardbus standard), which are connected directly to system bus 315 via corresponding Cardbus slots (not shown) and without intervening bridge circuits. In general, however, configuration controller 310 and components 320, 330, 340 are not limited to Cardbus components. For example, one or more of configuration controller 310 and components 320, 330, 340 may be a PCI component (i.e. operationally compliant with the PCI standard), which may be connected to system 300 via a corresponding PCI slot (not shown). System bus 315, configuration controller 310 and components 320, 330, 340 may also be operationally compliant with variants of the PCI standard, such as cPCI, PC/104+ or with other standards which are known to those skilled in the art or which will become known in the future and which are capable of functioning as described herein. For the purposes of explanation of system 300, it is assumed that configuration controller 310 and components 320, 330, 340 are Cardbus components and that system bus 315 operates on the Cardbus/PCI standard.

System 300 includes a clock generator circuit 350 that provides CCLK<0> to configuration controller 310 and one of CCLK<N:1> to each of components 320, 330, 340. System 300 may also include additional hardware (not shown) that is well known to those skilled in the art. System 300 may generally comprise any system. The inventive aspects of system 300 should not be limited by the nature of the particular system in which they are deployed. While three components 320, 330, 340 are depicted in the embodiment of FIG. 12, those skilled in the art will appreciate that system 300 may accommodate a different number of components and that components 320, 330, 340 used in system 300 may generally comprise any type of digital and/or digitally controlled components that perform any type of function.

In the embodiment of FIG. 12, clock generator circuit 350 is capable of outputting each of the CCLK<N:0> signals at a variety of frequencies. In some embodiments, clock generator circuit 350 is capable of outputting each of the CCLK<N:0> signals at a plurality of discrete frequency levels, which may be between 0-133 MHz for example. In one particular embodiment, clock generator circuit 350 is capable of outputting each of the CCLK<N:0> signals at one of 33, 66 and 133 MHz. As discussed above, the nominal frequency of PCI/Cardbus components is typically 33 MHz. However, some Cardbus, PCI or PCI variant components are capable of operating at frequencies higher than the nominal frequency provided by the PCI/Cardbus standard. In particular, there are PCI standard specifications for operation at 66 and 133 MHz. If clock generator circuit 350 determines that both the initiator and target components of a transaction are capable of operating at frequencies above the nominal frequency, then clock generator circuit 350 may provide higher frequency CCLK signals to the initiator and target components, such that at least a portion of the transaction may occur at a higher frequency. In this manner, system 300 takes advantage of any of its configuration controller 310 and/or its components 320, 330, 340 which may be capable of operating at higher frequencies.

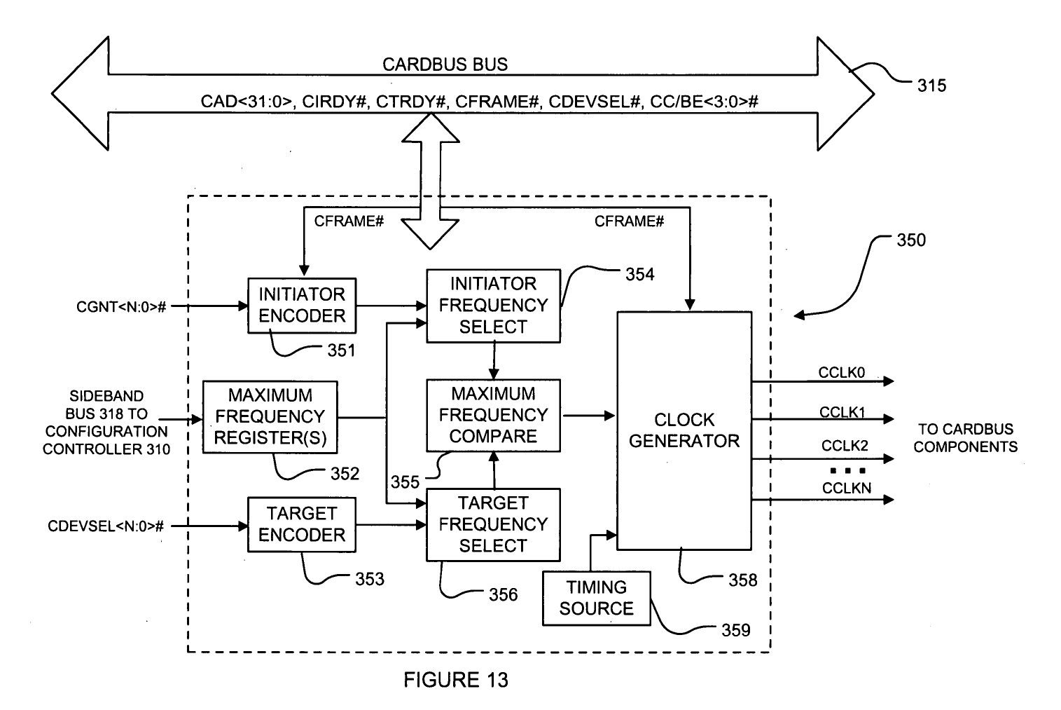

FIG. 13 schematically depicts a number of the components of clock generator circuit 350 in accordance with a particular embodiment of the invention. In the embodiment of FIG. 13, clock generator circuit 350 comprises: an initiator encoder circuit 351 for determining the initiator of a particular transaction; maximum frequency register(s) 352 for storing the maximum operational frequency of each component in system 300; a target encoder circuit 353 for determining the target of a particular transaction; an initiator frequency select circuit 354, a target frequency select circuit 356 and a maximum frequency compare circuit 355 for determining whether the operating frequency of a portion of the transaction may be increased; and a clock generator 358 and timing source 359 for outputting the CCLK<N:0> signals at the desired frequencies. Those skilled in the art will appreciate that the FIG. 13 representation of clock generator circuit 350 is simplified for the purposes of explanation and that clock generator circuit 350 may comprise additional components which are not shown in FIG. 13.

FIG. 14 schematically depicts a method 360 for providing bussed communications at various operational frequencies on system 300 (FIG. 12 and 13) according to a particular embodiment of the invention. Method 360 commences at block 362 and proceeds immediately to block 364, where system 300 is configured. Block 362 configuration may comprise one or more configuration transactions. Preferably, configuration controller 310 is the initiating component for the block 364 configuration transactions. Preferably, the block 364 configuration transactions occur at the nominal operating frequency of system 300.

In the embodiment of FIGS. 12 and 13, the block 364 configuration transactions are similar to the configuration transactions of method 260 (FIG. 11) described above, where configuration controller 310 uses sideband bus 318 to convey information to clock generator circuit 350 about the target component for a particular configuration transaction and clock generator circuit 350 suppresses the CCLK signals corresponding to the non-addressed components. In other embodiments, the block 364 configuration transactions are similar to the configuration transactions of method 160 (FIG. 9) described above, where clock generator circuit 350 decodes information about the target component for a particular configuration transaction from the CAD<31:11> and CC/BE<3:0># lines during the address phase and suppresses the CCLK signals corresponding to the non-addressed components. In still other embodiments, the block 364 configuration transactions are implemented using a bridge circuit that decodes the intended target component during the address phase of a configuration transaction and provides point to point connections to the addressed component.

System 300 provides clock generator circuit 350 with information about whether configuration controller 310 and/or any of components 320, 330, 340 are capable of operating at frequencies above the nominal frequency. Preferably, this information is obtained by clock generator circuit 350 as a part of or at the conclusion of the block 364 configuration. Configuration controller 310 may probe the components 320, 320, 330 to determine their maximum operational frequencies (i.e. their maximum CCLK frequencies). This maximum frequency information may be obtained by configuration controller 310 using conventional configuration transactions. In one particular embodiment, configuration controller 310 conducts a configuration read transaction for each component 320, 330, 340 and each component 320, 330, 340 makes their maximum operational frequency available on system bus 315. Configuration controller 310 may be aware of its own maximum operational frequency or it may conduct a similar configuration read transaction to determine its own maximum operational frequency. In other embodiments, the maximum frequency information for configuration controller 310 and components 320, 330, 340 is hard-coded into software associated with configuration controller 310 or with clock generator circuit 350.

In block 366, the maximum operational frequencies for configuration controller 310 and each component 320, 330, 340 are communicated to and stored by clock generator circuit 350. In the embodiment of FIGS. 12 and 13, this maximum frequency information is communicated to clock generator circuit 350 via sideband bus 318 and is stored in maximum frequency register(s) 352 (FIG. 13). In other embodiments, configuration controller 310 causes the individual components to communicate their maximum operational frequency directly to clock generator circuit 350 via system bus 315, via one or more other sideband buses (not shown) or via independent signal lines (not shown) and clock generator circuit 350 stores this maximum frequency information in its maximum frequency register(s) 352.

Block 368 involves waiting for a transaction to start and then determining whether the transaction is to be a configuration transaction or a conventional transaction. In the embodiment of FIGS. 12 and 13, configuration controller 310 informs clock generator circuit 350 when a configuration transaction is about to start over sideband bus 318. In other embodiments, the block 368 inquiry to determine whether the transaction is a configuration transaction is similar to the 5 combination of blocks 164 and 168 of method 160 (FIG. 9) described above, where clock generator circuit 350 monitors the CFRAME# signal on system bus 315 to determine when the address phase of a new transaction is occurring and the CC/BE<3:0># signals to determine if the command to be executed is a configuration command. If the block 368 inquiry determines that the transaction is a configuration transaction, then system 300 implements a configuration transaction in block 370. The block 370 configuration transactions may occur according to any of the methods described above for block 364. At the conclusion of block 370, method 360 loops back to block 368 to await another transaction.

If the block 368 inquiry determines that the next transaction is a conventional transaction, method 360 proceeds to block 374. Block 374 involves identifying which of configuration controller 310 and components 320, 330, 340 is the initiator for the particular transaction and the initiator's maximum operational frequency. In the embodiment of FIG. 13, the CGNT<0># signal for configuration controller 310 and the CGNT<N:1># signals for components 320, 330, 340 are provided to the initiator encoder circuit 351 of clock generator circuit 350. As discussed above, CGNT<N:0># are used by arbiter 312 to grant control of system bus 315 to a particular component that will be the initiator of the next transaction. Accordingly, the CGNT<N:0># signals allow initiator encoder circuit 351 to identify which of configuration controller 310 and components 320, 330, 340 is the initiator of a particular transaction. In the embodiment of FIG. 13, initiator encoder circuit 351 also accesses CFRAME# from system bus 315. CFRAME# may be used by initiator encoder circuit 351 to determine when the information on the CGNT<N:0># lines indicates a valid initiator.

Once the initiator is identified, then clock generator circuit 350 determines the initiator's maximum operational frequency. In the embodiment of FIG. 13, initiator encoder circuit 351 communicates the identity of the initiator to initiator frequency select circuit 354. Initiator frequency select circuit 354 then accesses the maximum operational frequency of the identified initiator from maximum frequency register(s) 352. For the purposes of explanation of method 360, it is assumed that the initiator is component 320 and that its maximum operational frequency is 66 MHz.

Block 376 involves identifying which of configuration controller 310 and components 320, 330, 340 is the target for the particular transaction and the target's maximum operational frequency. Clock generator circuit 350 may identify the target for a particular transaction using a number of techniques. System 300 is configured such that clock generator circuit 350 has independent (i.e. non-bussed) access to the CDEVSEL<0># pin of configuration controller 310 and to the CDEVSEL<N:1># pins for components 320, 330, 340. As discussed above, the CDEVSEL# is a signal on system bus 315 that is asserted by the target component to acknowledge that it has been addressed during the address phase as the intended target for a particular transaction. Accordingly, independent non-bussed access to the CDEVSEL<N:0># pins of configuration controller 310 and components 320, 330, 340 allows clock generator circuit 350 to identify which component is the target for a particular conventional transaction. In the embodiment of FIGS. 12 and 13, the CDEVSEL<N:0># pins of configuration controller 310 and components 320, 330, 340 are independently and directly connected to target encoder circuit 353, which identifies which of configuration controller 310 and components 320, 330, 340 is the target for the particular transaction. The CDEVSEL<N:0># pins of configuration controller 310 and components 320, 330, 340 are independently and directly connected to target encoder circuit 353 may be implemented using open collector outputs for example. When one of the CDEVSEL<N:0># pins at clock generator circuit 350 is asserted, clock generator 350 reflects a CDEVSEL# signal back to the initiator component and optionally to the other non-participating components of system 300. In some embodiments, the CDEVSEL# pin on system bus 315 is additionally or alternatively asserted.

In other embodiments, clock generator circuit 350 is provided with independent (i.e. non-bussed) access to the TRDY<N:0># pins of each of configuration controller 310 and components 320, 330, 340 (in addition to or as an alternative to CDEVSEL<N:0>#) to identify which of configuration controller 310 and components 320, 330, 340 is the target for a particular transaction. In still other embodiments, clock generator circuit 350 is provided with addressing information (i.e. address mapping) for components 320, 330, 340 and for configuration controller 310. In such embodiments, clock generator circuit 350 may decode the signals present on the CAD<31:0> lines of system bus 315 during the address phase of a particular transaction to indentify which component is the target for that particular transaction. The address mapping information may be determined as a part of the configuration of system 300 and may be communicated to clock generator circuit 350 for storage in its memory registers. The address mapping information may be communicated from configuration controller 310 to clock generator circuit 350 via sideband bus 318 during or at the conclusion of the configuration of system 300. In alternative embodiments, configuration controller 310 and the individual components 320, 330, 340 communicate their address mapping information directly to clock generator circuit 350 via system bus 315, via one or more other sideband buses (not shown) or via independent signal lines (not shown).

Once the target is identified, then clock generator circuit 350 determines the target's maximum operational frequency. In the embodiment of FIG. 13, target encoder circuit 353 communicates the identity of the target to target frequency select circuit 356. Target frequency select circuit 356 then accesses the maximum operational frequency of the identified target from maximum frequency register(s) 352. For the purposes of explanation of method 360, it is assumed that the target component is component 330 and that its maximum operational frequency is 133 MHz.

Block 378 involves a query as to whether both the initiator and target components are capable of operating at frequencies above the nominal frequency. If both components are capable of operating at frequencies above the nominal frequency, then clock generator circuit 350 adjusts the CCLK signals corresponding to the initiator and target components in block 380. At the conclusion of the block 380 frequency adjustment, the CCLK signals corresponding to the initiator and target components should be provided with a CCLK signal frequency that is acceptable to both the initiator and the target. Accordingly, the maximum CCLK frequency for the initiator and target components at the conclusion of block 380 is limited by the slower one of the initiator and target components. In the illustrative example, where initiator component 320 is capable of operating at 66 MHz and target component 330 is capable of operating at 133 MHz, block 380 involves increasing CCLK<1> and CCLK<2> to 66 MHz. The CCLK signals for non-addressed components (i.e. in the example transaction, CCLK<0> of configuration controller 310 and CCLK<N> of component 340) are maintained at the nominal frequency. If the block 378 inquiry indicates that one (or both) of the initiator and target components are constrained to operate at the nominal frequency, then block 380 is bypassed and all of the CCLK signals are maintained at the nominal frequency.

In the embodiment of FIG. 13, blocks 378 and 380 are implemented by maximum frequency select circuit 355. Maximum frequency select circuit 355 receives the maximum operational frequency of the initiator from initiator frequency select circuit 354 and the maximum operational frequency of the target from target select circuit 356. Maximum frequency select circuit 355 uses this maximum frequency information to instruct clock generator 358 such that clock generator 358 outputs the CCLK signals corresponding to the initiator and target components at a frequency that matches the lower of the maximum operational frequency of the initiator and the maximum operational frequency of the target.

A data phase occurs in block 382. The data phase in block 382 is substantially similar to the data phases described above, except that it may be occurring at a higher operational frequency. Block 384 involves determining whether the transaction is complete. Block 384 may be similar to block 182 of method 160 (FIG. 9) and may involve clock generator circuit 350 monitoring the CIRDY# and CFRAME# signals to determine if both CIRDY# and CFRAME# are deasserted at the same time. If the block 384 inquiry indicates that the transaction is not completed, then method 360 loops back to block 382, where it conducts another data phase. On the other hand, if the transaction is completed, then method 360 proceeds to block 386 where clock generator circuit 350 resets all of the CCLK<N:0> signals to the nominal frequency (see the discussion below about the transition back to nominal frequency). Resetting the In block 388, method 360 returns to block 368, where system 300 waits for a new transaction. In other embodiments, the block 384 inquiry concludes that the transaction is complete as soon as CFRAME# goes high (i.e. without considering CIRDY#). In such embodiments, there is a potential that the last data phase of the transaction could occur after block 384 and that the last data phase of the transaction could occur at the nominal frequency rather than at the increased frequency (see the discussion below about the transition back to nominal frequency).

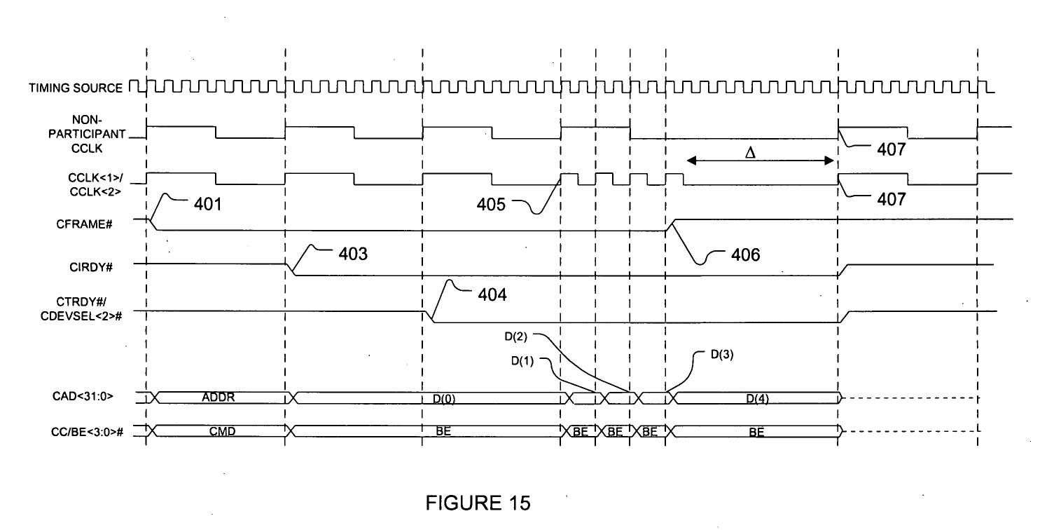

FIG. 15 is a schematic depiction of timing waveforms for a number of pins involved in a conventional write transaction of the type that may be implemented by system 300 and method 360. For the purposes of explaining FIG. 15, it is assumed that the nominal frequency of system 300 is 33 MHz, component 320 (corresponding to CCLK<1> ) is the initiator and is capable of operating at 133 MHz and component 330 (corresponding to CCLK<2>) is the target and is capable of operating at 266 MHz.

Prior to the commencement of the waveforms on FIG. 15, bus 315 is idle (i.e. CFRAME# and CIRDY# are both deasserted). During this period of time, CREQ<1># (not shown in FIG. 15) may be asserted, as the initiator component 320 requests control of bus 315. Bus arbiter 312 may then grant initiator component 320 control of bus 315 by asserting CGNT<1># (not shown in FIG. 15). As discussed above, clock generator circuit 350 may use CGNT<1># (and possibly CFRAME#) to determine that component 320 is the initiator for the FIG. 15 transaction. As indicated at 401, initiator component 320 then asserts CFRAME#, commencing the address phase of the transaction. At the outset of the transaction and during the address phase of the transaction, all CCLK signals (CCLK<N:0>) operate at the nominal frequency. As a part of the address phase, initiator component 320 applies a write command (indicated by CMD) on CC/BE<3:0># and applies the coded address of target component 330 (indicated by ADDR) on CAD<31:0>. As discussed above, clock generator circuit 350 may determine that component 330 is the intended target of the FIG. 15 transaction by decoding the address ADDR applied on CAD<31:0> during the address phase.

After the address phase, initiator component 320 asserts CIRDY# (as shown at 403) to indicate that it is ready to drive data onto bus 315. In the FIG. 15 transaction, as shown at 404, target component 330 asserts its CDEVSEL<2># and its CTRDY# pins one clock cycle later to indicate that it is ready to receive data. As discussed above, clock generator circuit 350 may determine that component 330 is the intended target of the FIG. 15 transaction by detecting the transition of the CDEVSEL<2># signal directly from target component 330 (i.e. independently of bus 315). As discussed above, when target component 330 asserts its CDEVSEL<2># pin, clock generator reflects a CDEVSEL# signal back at least to the CDEVSEL# line of initiator component 320. During the first clock cycle when CIRDY# and CTRDY# are both asserted, a first data phase occurs (indicated at D(0)). During the first data phase D(0) initiator component 320 writes data on CAD<31:0> and target component 330 reads the data from CAD<31:0>.

Before the end of the first data phase D(0), clock generator circuit 350 has determined that component 320 is the initiator component and that component 330 is the target component. Accordingly, on the next rising clock edge, clock generator circuit 350 increases the frequency of the CCLK<1> and CCLK<2> signals corresponding to initiator component 320 and target component 330, as indicated at 405. In the FIG. 15 example, clock generator circuit 350 raises the frequency of CCLK<1> and CCLK<2> to 133 MHz (i.e. quadruple the nominal frequency), which is the highest frequency supported by both initiator component 320 and target component 330. As shown in FIG. 15, a number of the subsequent data phases (indicated at D(1), D(2) and D(3)) occur at quadruple the nominal frequency.

As indicated at 406, initiator component 320 deasserts CFRAME# to indicate that data phase D(4) is the last data phase of the FIG. 15 transaction. When CFRAME# is deasserted, clock generator circuit 350 considers the state of the CCLK signals corresponding to the non-participating components (and possibly the CCLK signals corresponding to the participating components) and determines whether they must be suppressed, extended or otherwise manipulated prior to returning all of the CCLK signals to the nominal frequency. Manipulation of the CCLK signals may be required, so that the non-participating components are capable of interpreting valid timing information and valid signals on their pins.

More particularly, the non-participating components may be slower than the participating components and may require certain set-up periods in order to interpret valid signals on their pins and to allow the next transaction to begin. All potential initiator components for the next transaction should be capable of correctly decoding the “bus idle” condition (CFRAME# and CIRDY# deasserted), so that, if desired, they can claim the bus for the next transaction. Likewise, all potential target components for the next transaction should be capable of correctly capturing the address phase of the next transaction. For these reasons, it is preferable that transactions wherein one or more data phase(s) occur at frequencies above the nominal frequency end with a data phase that occurs at the nominal system frequency. Once all potential targets have captured the address phase of the next transaction, then the clock frequency may be increased for the data phase(s) of the next transaction in a manner similar to that described above.

During periods of time when system 300 is running above its nominal frequency, non-participating components may receive signals that are not otherwise compatible with their slower timing requirements and/or their clock signal inputs (which remain at the nominal frequency). Non-participating components ignore such signals, because they recognize that they are not participating in the transaction. These non-participating components may wait for a bus idle condition (i.e. CFRAME# and CIRDY# both deasserted), before they respond to any signals on the bus. Preferably, as discussed above, all clock signals are returned to the nominal system frequency by the time that CFRAME# and CIRDY# are both deasserted.

In the illustrated embodiment, both the participating and non-participating CCLK signals are suppressed for a delay period A, such that the next rising CCLK edge (indicated at 407) occurs after delay period A. In general, clock generator circuit 350 regulates the transition of the CCLK signals down to the nominal operating frequency in such a manner that the non-participating ones of configuration controller 310 and components 320, 330, 340 see valid signals on system bus 315 and are made capable of participating in a subsequent transaction. Clock generator circuit 350 may provide such a transition back to the nominal frequency by stretching, gating or otherwise manipulating the CCLK signals corresponding to participating and/or non-participating components.

In some embodiments, clock generator circuit 350 makes a decision as to how to manipulate the CCLK signals on the basis of the temporal location of the deassertion of CFRAME# relative to a nominal frequency CCLK period. For example, the participating initiator component may deassert CFRAME# sufficiently early in a nominal CCLK period, that the non-participating components will see valid data on their pins (i.e. have sufficient set-up periods) if the next rising edge occurs at its normal time. In such a circumstance, clock generator circuit 350 need not manipulate the CCLK signals corresponding to the non-participating components.

In some circumstances, one or more components in a system comprise phase-lock-loop (PLL) timing circuitry in their PCI clock path. Components which comprises PLL timing circuitry may be incapable of operating correctly when their clock signals are varied on a cycle-to-cycle basis. In accordance with an alternative embodiment of the invention, a method is provided for configuring systems which incorporate components having PLL timing circuitry. In accordance with this embodiment of the invention, the PLL-based components each comprise a local controllable IDSEL software signal. When the IDSEL switch associated with a particular PLL-based component is asserted, then that PLL-based component activates its target configuration circuitry as if it was going to be the target of the next configuration transaction. When the IDSEL switch associated with a particular PLL-based component is deasserted, then that PLL-based component deactivates its target configuration circuitry, so that it will ignore all configuration transactions occurring on the bus.

In the illustrated embodiment, there is no transaction which immediately follows the FIG. 15 transaction. Accordingly, CFRAME# remains deasserted after the rising clock edge 407 and CAD<31:0> and CCBE<3:0> are tri-stated. In some embodiments, a subsequent transaction will follow immediately after the FIG. 15 transaction, in which case, immediately following rising clock edge 407, the initiator of the subsequent transaction may assert CFRAME#, drive the target component address onto CAD<31:0> and drive CC/BE<3:0># with the subsequent command.

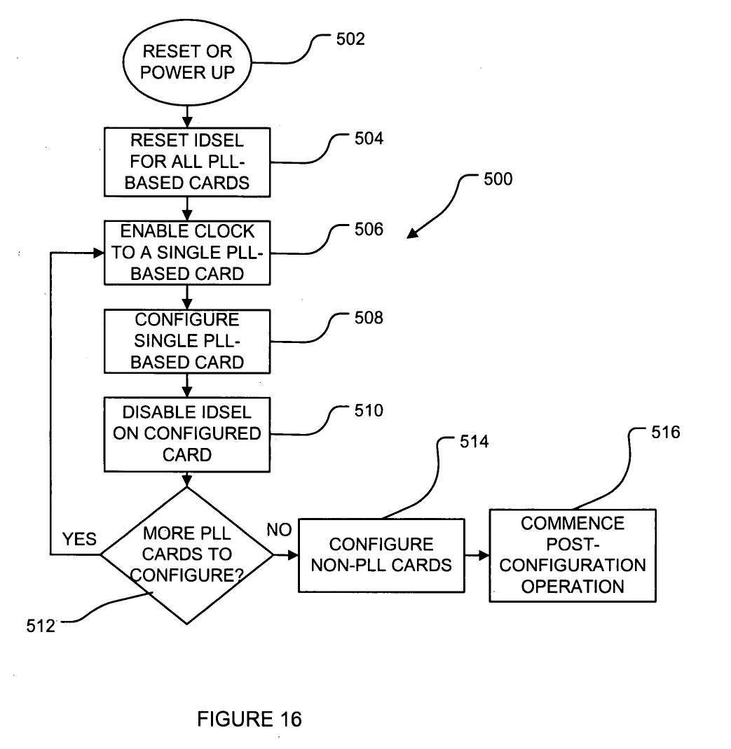

FIG. 16 schematically depicts a method 500 for configuring systems which incorporate PLL-based components. After a reset or power up in block 502, method 500 proceeds to block 504, where the local controllable IDSEL software switch is reset for each PLL-based component in the system. In some embodiments, the IDSEL switch of PLL-based component(s) may reset automatically. In such embodiments, block 504 is not necessary. At the conclusion of block 504, the IDSEL switch for each PLL-based component is asserted, so that the target circuitry for each PLL-based component is active.

In block 506, a clock signal is provided to a single PLL-based component and is suppressed from all other non-configured PLL-based component(s). The PLL-based component that receives its clock signal is then configured in block 508. Block 508 may comprise a plurality of configuration transactions. The other PLL-based component(s) do not participate in the block 508 configuration transaction(s), because they do not receive a clock signal or because their IDSEL switches have been deasserted (see below). In block 510, the IDSEL switch for the component configured in block 508 is deasserted, so that the component configured in block 508 does not participate in further configuration transactions.

In block 512, a decision is made as to whether there are additional PLL-based component(s) to configure. If so, then method 500 loops back to block 506 and repeats the configuration process again. However, on the second and subsequent times through blocks 506, 508, 510, the clock signal(s) corresponding to previously configured PLL-based component(s) are not suppressed. Clock signal(s) may be provided to the previously configured PLL-based component(s) because these previously configured component(s) have their respective IDSEL switches deasserted. In accordance with method 500, once a clock signal is provided to a PLL-based component (i.e. in block 506), a constant frequency clock signal is maintained for that component to facilitate operation of its PLL timing circuitry.

When it is decided in block 512 that there are no more PLL-based components to configure, then method 500 proceeds to block 514 where non-PLL cards are configured. Block 514 configuration may occur in accordance with any of the methods described above, except that the clock signals associated with PLL-based components are not suppressed, because the PLL-based components have their respective IDSEL switches deasserted. After configuration of the non-PLL based cards in block 514, conventional (i.e. non-configuration) operation commences in block 516.

The sequence of configuring PLL-based components (blocks 506, 508, 510) and non-PLL-based components (block 514) may be switched or interleaved, provided that once the clock signal is supplied to a PLL-based component, the clock signal is maintained thereafter and that once a PLL-based component is configured, its IDSEL switch is disabled, such that it is not targeted by subsequent configuration transactions.

As will be apparent to those skilled in the art in the light of the foregoing disclosure, many alterations and modifications are possible in the practice of this invention without departing from the spirit or scope thereof. For example:
Those skilled in the art will appreciate that there are many instances where the methods illustrated and described in FIGS. 2A, 2B, 3, 9, 11 and 14 do not necessarily have to be executed in the sequential order illustrated and described above. For example, in method 80 of FIG. 3, the maximum initiator frequency in block 85 may be determined prior to the maximum target frequency in block 84 or in method 160 of FIG. 9, determining the target component in block 172 may occur before assertion of clock gate enable signal 158 in block 170. In addition, those skilled in the art will appreciate that there are many instances where the processes performed in each block of the methods illustrated and described above may overlap with processes performed in other blocks. For example, in method 360 of FIG. 14, the inquiry into whether a transaction is complete in block 384 may be performed at the same time or may overlap with the data phase occurring in block 382 or in method 160 of FIG. 9, determining the target component in block 172 may overlap with the assertion of clock gate enable signal 158 in block 170. In general, those skilled in the art will appreciate that the reduction of the methods of the invention to the flow chart diagrams illustrated and described in FIGS. 2A, 2B, 3, 9, 11 and 14 is for the purposes of explanation only and should not be interpreted in a limiting sense.
FIGS. 2A and 2B respectively represent schematic depictions of methods for performing conventional and configuration transactions on system 55. Those skilled in the art will appreciate that method 60A (FIG. 2A) and method 60B (FIG. 2B) may be combined into a unitary method for performing conventional and configuration transactions on system 55.
In the embodiment of FIGS. 7-9 discussed above, command decoder 152 monitors CIRDY# and CFRAME# in block 182 (FIG. 9) to determine if a configuration transaction has terminated. If the configuration transaction has terminated then command decoder 152 uses clock gate enable signal 158 to discontinue suppression of the non-addressed CCLK signals in block 184. In alternative embodiments, CIRDY# and CFRAME# are independently monitored in block 182 by clock gate 154 and when clock gate 154 detects that both CIRDY# and CFRAME# are deasserted (i.e. the end of a configuration transaction), clock gate 154 discontinues suppression of the non-addressed CCLK signals in block 184 and sends a signal (not shown) back to command decoder 152 to reset clock gate enable signal 158.
In the embodiments described above, the CCLK<N:1> signals are provided to their respective components at all times except during configuration transactions, when the CCLK<N:1> signals associated with all but the addressed one of the components are suppressed. Those skilled in the art will appreciate that the systems described above may comprise power management hardware and/or software, which may disable one or more of the CCLK<N:1> signals to conserve power when the system is not being actively used.
In the embodiments described above, CCLK<0> for the configuration controller is provided by the same clock generator circuit as CCLK<N:1> for all of the other components. However, CCLK<0> is not normally suppressed. In some embodiments, therefore, CCLK<0> may be provided independently. For example, systems according to the invention may comprise an independent clock circuit which provides CCLK<0> to the configuration controller, but does not interact with the other components.
The embodiments of system 300 and method 360 described above involve the storage of information relating to the maximum operational frequencies of configuration controller 310 and components 320, 330, 340 in the maximum frequency register(s) 352 of clock generator circuit 350. In alternative embodiments, such information may be stored in separate memory devices (not shown) which may be accessed by clock generator circuit 350.
In the configuration transactions described above, the CCLK signals corresponding to non-addressed components are suppressed. In other embodiments, the clock gate circuit is replaced by a different gate circuit that gates or otherwise suppresses other configuration transaction signals associated with the non-targeted components. For example, in system 100, if it was determined that component 120 was the intended target component for a configuration transaction, then a gate circuit could be provided that suppresses one or more of CFRAME#, CIRDY# and CGNT# associated with the non-addressed components 130, 140.
In the systems described above, the bus arbiter and clock generator circuits are depicted and described as residing on a passive backplane. In some embodiments, the bus arbiter is included in the configuration controller. In some embodiments, the clock generator circuit is provided as a part of the configuration controller.
Systems 100, 200, 300 may be linked to other systems and/or components using electrical and/or passive electromechanical bridges. Such bridges may connect the system bus to other busses which may operate in accordance with the PCI standard or with some other bussed communication standard. Similarly, bridges may be used to connect systems 100, 200, 300 to components that use different standards or form factors. For example, systems 100, 200, 300 may be provided with an electrical bridge to one or more 16-bit PC Card components.
The above description describes the generation and suppression of clock signals. Those skilled in the art will appreciate that a clock signal may be “suppressed” by simply not generating the clock signal. The various clock generator circuits described above may be configured to suppress a clock signal by not generating the signal. Accordingly, in this description and the accompanying claims, suppressing a clock signal should be understood to include not generating the clock signal. In addition, those skilled in the art will appreciate that in some embodiments, providing a clock signal to each component comprises generating a single clock signal and connecting the clock signal to each component.
The above description and the appended claims make use of signal and pin names that are common to the PCI and Cardbus protocols. Those skilled in the art will appreciate that this invention applies to other protocols including, without limitation, PCI variants. Such other protocols may adopt different signal and/or pin names. References to particular signal and/or pin names from the PCI or Cardbus protocols should be understood to include equivalent signal and/or pin names from other protocols.

Accordingly, the scope of the invention is to be construed in accordance with the substance defined by the following claims.

1. A method for conducting a transaction in a system incorporating a plurality of components connected to a system bus, the method comprising:
identifying participating components that are participating in the transaction from among the plurality of components;
selectively providing each of the participating components with a corresponding clock signal for at least a portion of the transaction, while suppressing clock signals associated with any non-participating components for at least the portion of the transaction; and
writing data to and reading data from the system bus to perform the transaction.

2. A method according to claim 1 wherein writing data to the system bus is performed by one of the participating components and reading data from the system bus is performed by another one of the participating components.

3. A method according to claim 1 wherein suppressing the clock signals associated with any non-participating components comprises suppressing one or more output signals of a clock generator circuit.

4. A method according to claim 1 comprising, upon determining that the transaction has ended, discontinuing suppressing the clock signals associated with non-participating components.

5. A method according to claim 1 wherein identifying participating components that are participating in the transaction from among the plurality of components comprises identifying a target component for the transaction.

6. A method according to claim 5 wherein identifying the target component for the transaction is performed using information obtained from at least one of: the system bus, a system controller, a system arbiter and one or more signals provided by one or more of the plurality of components.

7. A method according to claim 5 wherein identifying participating components that are participating in the transaction from among the plurality of components comprises identifying an initiator component for the transaction.

8. A method according to claim 7 wherein identifying the initiator component for the transaction is performed using information obtained from at least one of: the system bus, a system controller, a system arbiter and one or more signals provided by one or more of the plurality of components.

9. A method according to claim 7 wherein identifying the initiator component for the transaction comprises determining that the transaction is a configuration transaction for which a configuration controller is the initiator component.

10. A method according to claim 9 wherein determining that the transaction is a configuration transaction comprises using information obtained from the configuration controller which indicates that the transaction is a configuration transaction.

11. A method according to claim 10 wherein using information obtained from the configuration controller which indicates that the transaction is a configuration transaction comprises communicating with the configuration controller over a sideband bus.

12. A method according to claim 9 wherein identifying the target component for the transaction comprises using information obtained from the configuration controller which indicates the target component for the transaction.

13. A method according to claim 12 wherein using information obtained from the configuration controller which indicates the target component for the transaction comprises communicating with the configuration controller over a sideband bus.

14. A method according to claim 9 comprising upon determining that the transaction has ended, discontinuing suppressing the clock signals associated with non-participating components.

15. A method according to claim 14 wherein determining that the transaction has ended comprises using information obtained from the configuration controller which indicates the end of the transaction.

16. A method according to claim 15 wherein using information obtained from the configuration controller which indicates the end of the transaction comprises communicating with the configuration controller over a sideband bus.

17. A method according to claim 1 wherein the system and the system bus conduct the transaction in accordance with a bussed communication standard selected from among: a PCI standard; a Cardbus standard and a variant of the PCI standard.

18. A method according to claim 17 wherein identifying participating components that are participating in the transaction from among the plurality of components comprises identifying a target component for the transaction using information obtained from at least one of: the system bus, a system controller, a system arbiter and one or more signals provided by one or more of the plurality of components.

19. A method according to claim 18 wherein identifying the target component for the transaction comprises independently monitoring a DEVSEL# pin associated with each of the plurality of components.

20. A method according to claim 18 wherein identifying the target component for the transaction comprises independently monitoring a TRDY# pin associated with each of the plurality of components.

21. A method according to claim 18 wherein identifying the target component for the transaction comprises monitoring AD<31:0> lines of the system bus during an address phase of the transaction and decoding the address asserted thereon.

22. A method according to claim 18 wherein identifying participating components that are participating in the transaction from among the plurality of components comprises identifying an initiator component for the transaction using information obtained from at least one of: the system bus, a system controller, a system arbiter and one or more signals provided by one or more of the plurality of components.

23. A method according to claim 22 wherein identifying the initiator component for the transaction comprises independently monitoring a GNT# pin associated with each of the plurality of components.

24. A method according to claim 22 wherein identifying the initiator component for the transaction comprises independently monitoring a IRDY# pin associated with each of the plurality of components.

25. A method according to claim 18 wherein identifying participating components that are participating in the transaction from among the plurality of components comprises identifying an initiator component for the transaction and wherein the initiator component for the transaction comprises determining that the transaction is a configuration transaction for which a configuration controller is the initiator component.

26. A method according to claim 25 wherein determining that the transaction is a configuration transaction comprises monitoring C/BE<3:0># lines of the system bus during an address phase of the transaction.

27. A method according to claim 25 wherein determining that the transaction is a configuration transaction comprises using information obtained from the configuration controller which indicates that the transaction is a configuration transaction.

28. A method according to claim 27 wherein using information obtained from the configuration controller which indicates that the transaction is a configuration transaction comprises communicating with the configuration controller over a sideband bus.

29. A method according to claim 25 wherein identifying the target component for the transaction comprises monitoring at least a plurality of AD<31:0> lines of the system bus during an address phase of the transaction.

30. A method according to claim 25 wherein identifying the target component for the transaction comprises using information obtained from the configuration controller which indicates the target component for the transaction.

31. A method according to claim 30 wherein using information obtained from the configuration controller which indicates the target component for the transaction comprises communicating with the configuration controller over a sideband bus.

32. A method according to claim 25 comprising, upon determining that the transaction has ended, discontinuing suppressing the clock signals associated with non-participating components.

33. A method according to claim 32 wherein determining that the transaction has ended comprises using information obtained from the configuration controller which indicates the end of the transaction.

34. A method according to claim 33 wherein using information obtained from the configuration controller which indicates the end of the transaction comprises communicating with the configuration controller over a sideband bus.

35. A method according to claim 32 wherein determining the end of the transaction comprises monitoring a FRAME# line on the system bus.

36. A method according to claim 35 wherein determining the end of the transaction comprises monitoring a IRDY# line on the system bus.

37. A method according to claim 17 wherein suppressing the clock signals associated with non-participating components comprises suppressing one or more output signals of a clock generator circuit.

38. A method according to claim 20 comprising, upon determining that the transaction has ended, discontinuing suppressing the clock signals associated with non-participating components.

39. A method according to claim 38 wherein determining that the transaction has ended comprises monitoring FRAME# line on the system bus.

40. A method according to claim 39 wherein determining that the transaction has ended comprises monitoring IRDY# line on the system bus.

41. A method according to claim 1 wherein, if the participating components are capable of operating at a clock frequency that is higher than a nominal system clock frequency, then selectively providing each of the participating components with a corresponding clock signal for at least a portion of the transaction comprises selectively providing each of the participating components with a corresponding clock signal at an increased frequency for a portion of the transaction and suppressing clock signals associated with any non-participating components comprises providing clock signals to the non-participating components at a nominal system frequency.

42. A method according to claim 41 comprising, upon determining that the transaction is coming to an end, manipulating the clock signals associated with the participating and non-participating components such that all components see valid timing on the bus.

43. A method according to claim 42 wherein manipulating the clock signals associated with the participating and non-participating components comprises gating the clock signals for a period of time.

44. A method according to claim 17 wherein, if the participating components are capable of operating at a clock frequency that is higher than a nominal system clock frequency, then selectively providing each of the participating components with a corresponding clock signal for at least a portion of the transaction comprises selectively providing each of the participating components with a corresponding clock signal at an increased frequency for a portion of the transaction and suppressing clock signals associated with any non-participating components comprises providing clock signals to the non-participating components at a nominal system frequency.

45. A method according to claim 44 comprising, upon determining that the transaction is coming to an end, manipulating the clock signals associated with the participating and non-participating components such that all components see valid timing on the bus.

46. A method according to claim 45 wherein manipulating the clock signals associated with the participating and non-participating components comprises gating the clock signals for a period of time.

47. A method for conducting a transaction in a system incorporating a plurality of components connected to a system bus, the method comprising:
identifying participating components that are participating in the transaction from among the plurality of components;
if the participating components are capable of operating at a clock frequency that is higher than a nominal system clock frequency, selectively providing each of the participating components with a corresponding clock signal at an increased frequency for a portion of the transaction; and
writing data to and reading data from the system bus to perform the transaction.

48. A method according to claim 47 comprising, upon determining that the transaction is coming to an end, manipulating the clock signals associated with the participating and non-participating components such that all components see valid timing on the bus.

49. A method according to claim 48 wherein manipulating the clock signals associated with the participating and non-participating components comprises gating the clock signals for a period of time.

50. A method for conducting a transaction in a system incorporating a plurality of components connected to a system bus, the method comprising:
generating a plurality of clock signals, each of the plurality of clock signals corresponding to one of the of plurality components;
identifying participating components that are participating in the transaction from among the plurality of components;
based on which of the plurality of components are the participating components in the transaction, adjusting one or more of the clock signals for at least a portion of the transaction; and
writing data to and reading data from the system bus to perform the transaction.

51. A method according to claim 50 wherein adjusting one or more of the clock signals for at least a portion of the transaction comprises providing the participating components with their corresponding clock signals, while suppressing the clock signals associated with any non-participating components.

52. A method according to claim 50 wherein adjusting one or more of the clock signals for at least a portion of the transaction comprises selectively providing the participating components with their corresponding clock signals at an increased frequency for a portion of the transaction, if the participating components are capable of operating at a clock frequency that is higher than a nominal system clock frequency.

53. A system comprising:
a system bus;
a plurality of components, each of the components connected directly to the system bus for conducting transactions with each of the other components over the system bus; and
a clock generator circuit for providing a plurality of clock signals, each of the plurality of clock signals corresponding to one of the plurality of components;
wherein the clock generator circuit is configured to determine which of the plurality of components are participating components in a transaction occurring over the system bus and, based on which of the plurality of components are the participating components in the transaction, adjusting one or more of the clock signals for at least a portion of the transaction.

54. A system according to claim 53 wherein the clock generator circuit is configured to provide the participating components with their corresponding clock signals, while suppressing the clock signals associated with any non-participating components.

55. A system according to claim 53 wherein the clock generator circuit is configured to selectively provide the participating components with their corresponding clock signals at an increased frequency for a portion of the transaction, if the participating components are capable of operating at a clock frequency that is higher than a nominal system clock frequency.
